(19) United States
(12) Patent Application Publication
(10) Pub. No.: US 2026/0039843 A1
(43) Pub. Date: Feb. 5, 2026

(54) IMAGE PROCESSING METHOD AND APPARATUS AND DEVICE

(71) Applicant: Tencent Technology (Shenzhen) Company Limited, Shenzhen (CN)

(72) Inventor: Liqiang WANG, Shenzhen (CN)

(21) Appl. No.: 19/351,048

(22) Filed: Oct. 6, 2025

Related U.S. Application Data
(63) Continuation of application No. PCT/CN2024/108798, filed on Jul. 31, 2024.

(30) Foreign Application Priority Data
Aug. 20, 2023 (CN) 202311051390.0

(51) Int. Cl. H04N 19/189; H04N 19/176; H04N 19/186

(52) U.S. Cl. CPC H04N 19/189; H04N 19/176; H04N 19/186

(57) ABSTRACT

This application provide an image processing method performed by a computer device. The method includes: determining a current coding block in an image bitstream, the current coding block comprising a first component and a second component; obtaining a cross-component prediction model, the cross-component prediction model indicating a mapping relationship between the first component of the current coding block and the second component of the current coding block; performing cross-component prediction on the current coding block based on the mapping relationship by inputting a reconstructed value of the first component of the current coding block to the cross-component prediction model to obtain a predicted value of the second component of the current coding block; and reconstructing the current coding block using the reconstructed value of the first component and the predicted value of the second component of the current coding block.

### CROSS-REFERENCE TO RELATED APPLICATIONS

This application is a continuation application of PCT Patent Application No. PCT/CN2024/108798, entitled “IMAGE PROCESSING METHOD AND APPARATUS AND DEVICE” filed on Jul. 31, 2024, which claims priority to Chinese Patent Application No. 202311051390.0, entitled “IMAGE PROCESSING METHOD AND APPARATUS AND DEVICE” filed with the China National Intellectual Property Administration on Aug. 20, 2023, both of which are incorporated herein by reference in their entirety.

### FIELD OF THE TECHNOLOGY

This application relates to the field of audio and video technologies, in particular, to the field of video coding and decoding, and specifically, to an image processing method, an image processing apparatus, and a computer device.

### BACKGROUND OF THE DISCLOSURE

Intra-frame prediction is one of core technologies of current video coding technologies, and refers to a process of predicting a value of a to-be-coded pixel in a current image frame according to a value of a coded pixel in the current image frame.

Currently, a mainstream intra-frame prediction technology mainly generates a predicted image along an assumed direction based on neighboring pixels by using a manually designed filter. During the intra-frame prediction, it is very difficult to deal with complex and diversified image features only by using a small quantity of reconstructed neighboring pixels and a manually designed simple filter. Consequently, image frame prediction precision is relatively low.

### SUMMARY

Embodiments of this application provide an image processing method and apparatus and a device, which can significantly improve intra-frame prediction accuracy.

According to one aspect, an embodiment of this application provides an image processing method, including:
determining a current coding block in an image bitstream, the current coding block comprising a first component and a second component;
obtaining a cross-component prediction model, the cross-component prediction model indicating a mapping relationship between the first component of the current coding block and the second component of the current coding block;
performing cross-component prediction on the current coding block based on the mapping relationship by inputting a reconstructed value of the first component of the current coding block to the cross-component prediction model to obtain a predicted value of the second component of the current coding block; and
reconstructing the current coding block using the reconstructed value of the first component and the predicted value of the second component of the current coding block.

According to another aspect, an embodiment of this application provides a computer device, including:
a processor, configured to load and execute a computer program; and
a computer-readable storage medium, having a computer program stored therein, the computer program, when executed by a processor of the computer device, causing the computer device to implement the foregoing image processing method.

According to another aspect, this application provides a non-transitory computer-readable storage medium, having a computer program stored therein, the computer program being configured to be loaded and executed by a processor of a computer device and causing the computer device to perform the foregoing image processing method.

In the embodiments of this application, when a decoding end predicts the current coding block in the image bitstream, if the first component of the current coding block has been reconstructed to obtain the reconstructed value, the decoding end can input the reconstructed value of the reconstructed first component to the cross-component prediction model, where the cross-component prediction model indicates the mapping relationship between the first component and the second component of the current coding block. In this way, the predicted value of the second component of the current coding block may be calculated based on the reconstructed value of the first component of the current coding block by using the mapping relationship indicated by the cross-component prediction model, to implement cross-component prediction from the first component to the second component, thereby improving prediction efficiency. The cross-component prediction model is constructed based on similarity between mapping relationships between different components of reconstructed pixels in the image bitstream. The cross-component prediction model for indicating the mapping relationship between the first component and the second component of the current coding block is constructed based on similarity with a mapping relationship between components in the neighboring region of the current coding block. In this way, the cross-component prediction model can be refined, and higher-quality predicted pixels of the current coding block can be generated based on the refined cross-component prediction model, thereby significantly improving prediction quality and improving coding and decoding efficiency.

### BRIEF DESCRIPTION OF THE DRAWINGS

FIG. 1 is a schematic structural diagram of a video coder according to an exemplary embodiment of this application;

FIG. 2 is a schematic diagram of a video coding and decoding scenario according to an exemplary embodiment of this application;

FIG. 3 is a schematic flowchart of an image processing method according to an exemplary embodiment of this application;

FIG. 4 is a schematic diagram of a position of a current coding block in a current image according to an exemplary embodiment of this application;

FIG. 5 is a schematic flowchart of constructing a cross-component prediction model according to an exemplary embodiment of this application;

FIG. 6 is a schematic diagram of neighboring regions of a current coding block and a cross-component matching pair according to an exemplary embodiment of this application;

FIG. 7 is a schematic diagram of resampling a first component in a template region of a current coding block according to an exemplary embodiment of this application;

FIG. 8A is a schematic diagram of a size relationship between a plurality of neighboring regions of a current coding block according to an exemplary embodiment of this application;

FIG. 8B is a schematic diagram in which all sampling points in a target region are usable according to an exemplary embodiment of this application;

FIG. 9 is a schematic diagram of selecting some of a plurality of neighboring regions of a current coding block as a template region according to an exemplary embodiment of this application;

FIG. 10A is a schematic diagram of selecting sampling points based on coordinate positions of sampling points according to an exemplary embodiment of this application;

FIG. 10B is a schematic diagram of selecting sampling points at intervals according to an exemplary embodiment of this application;

FIG. 10C is a schematic diagram of selecting sampling points according to a scanning sequence according to an exemplary embodiment of this application;

FIG. 10D is a schematic diagram of selecting sampling points from a specified position of a template region of a current coding block according to an exemplary embodiment of this application;

FIG. 11 is a schematic diagram of extending boundary of a template region of a current coding block according to an exemplary embodiment of this application;

FIG. 12 is a schematic flowchart of another image processing method according to an exemplary embodiment of this application;

FIG. 13 is a schematic diagram of a cross-component matching pair according to an exemplary embodiment of this application;

FIG. 14 is a schematic structural diagram of a decoding apparatus according to an exemplary embodiment of this application;

FIG. 15 is a schematic structural diagram of a coding apparatus according to an exemplary embodiment of this application; and

FIG. 16 is a schematic structural diagram of a computer device according to an exemplary embodiment of this application.

### DESCRIPTION OF EMBODIMENTS

In order to have a clearer understanding of the technical solution provided in the embodiments of this application, the key terms involved in the embodiments of this application will be introduced first:

### I. Video Coding Technology

A video coding technology is a coding scheme of converting a file in an original video format into a file in another video format through a compression technology. A video is a file formed by sequentially connecting at least two video frames (or referred to as image frames). In other words, a video frame is a smallest or most basic unit of a video. When a video is played, a plurality of video frames are continuously outputted according to a sequence of times at which the plurality of video frames are played. When more than 24 continuous video frames change per second, according to the persistence of vision principle of human eyes, human eyes obtain a visual effect that the video frames are smooth and continuous. A video is represented as a video signal and usually as an electrical video signal. Transmission and storage of a video in a network can be implemented by transmitting a video signal of the video. A video signal of a video may be obtained as follows: being captured by a camera or being generated by a computer device. Because statistical properties of different video signals are different, corresponding compression and coding schemes may also be different.

An existing mainstream video coding technology is described as follows:

According to modern mainstream video coding technologies, for example, high efficiency video coding (HEVC) such as HEVC/H.265, versatile video coding (VVC) such as VVC/H.266, and audio video coding standard (AVS), a hybrid coding framework is used and a series of operations and processing are performed on an inputted original video signal as follows:
1) Block partition structure: An inputted image (for example, a video frame that needs to be compressed, coded, or decoded in a video) is divided into several non-overlapping processing units based on a size of the inputted image. During coding and decoding, a similar compression operation may be performed on each processing unit, to avoid difficulty caused by directly coding and decoding a frame image. The processing unit obtained after division may be referred to as a coding tree unit (CTU) or a largest coding unit (LCU). The CTU as a processing unit may be further divided in a more fine-grained manner to obtain one or more basic coding units that are referred to as coding units (CU) or coding blocks. Each CU unit is the most basic element in a coding and decoding process. In subsequent embodiments of this application, each CU is used as an example for related description of coding and decoding.
2) Predictive coding: Predictive coding is to predict a predicted value of a current signal based on one or more previous signals of the current signal according to association between discrete signals (for example, spatial correlation between pixels of different parts in the same video frame or temporal correlation between pixels of different previous and following video frames), so as to code a residual (or referred to as a prediction error) of an actual value and the predicted value of the current signal. This avoids problems such as high calculation complexity and waste of compression resources that are caused by directly compressing all video frames.

Predictive coding mainly includes manners such as intra-frame prediction and inter-frame prediction. (1) Intra-frame prediction: A prediction signal for predicting a current coding unit comes from a region that has been coded and reconstructed in the same image. (2) Inter-frame prediction: A prediction signal for predicting a current coding unit comes from another image (which may be referred to as a reference image) that has been coded and that is different from an image to which the current coding unit belongs. During video coding and decoding, when coding a to-be-coded unit (for example, the CU mentioned above) in an original video signal (for example, a video frame), if using any predictive coding scheme (for example, intra-frame prediction or inter-frame prediction), a coding end needs to predict the to-be-coded unit by using a reconstructed video signal of the original video signal (for example, when the predictive coding scheme is intra-frame prediction, the reconstructed video signal belongs to the current image, or when the predictive coding scheme is inter-frame prediction, the reconstructed video signal comes from a previous image that has been reconstructed and that is of the current image), to obtain a residual video signal (for example, the residual mentioned above) of the current to-be-coded unit. In this way, after a bitstream is generated by compressing and coding the residual video signal, the bitstream may be transmitted from the coding end to the decoding end. Correspondingly, the coding end further needs to notify the decoding end of any predictive coding scheme used in the coding process, so that after receiving the coded bitstream (that is, the bitstream, or referred to as an image bitstream, a video bitstream, a compressed bitstream, or the like), the decoding end reconstructs an image in a decoding process of the coded bitstream by using a predictive coding scheme that is the same as that in the coding process.
3) Transform & Quantization: A residual video signal may be converted into transform domain through a transform operation such as discrete Fourier transform (DFT) or discrete cosine transform (DCT) and referred to as a transform coefficient. In this way, a lossy quantization operation may be further performed on a signal in the transform domain, and some information is discarded, so that a quantized signal facilitates compression and expression. In some video coding standards, there may be one or more transform manners. Therefore, during video coding and decoding, a coding end needs to select a transform manner for a current coding CU and notify a decoding end of the transform manner, so that the decoding end can perform inverse transform by using the corresponding transform manner in a decoding process. Quantization fineness of a quantization operation usually depends on a quantization parameter (QP). A larger value of the QP indicates that coefficients in a larger value range are to be quantized into the same output, which usually causes higher distortion and a lower bit rate (that is, a number of data bits transmitted per unit time during data transmission). On the contrary, a smaller value of the QP indicates that coefficients in a smaller value range are to be quantized into the same output, which usually causes lower distortion and a higher bit rate.
4) Entropy coding or statistical coding: Statistical compression coding is performed on quantized transform-domain signals according to statistical coding (that is, statistical compression coding is performed according to frequencies of occurrence of values), and finally a binarized (0 or 1) compressed bitstream is outputted. In addition, entropy coding also needs to be performed on other information generated through coding, such as a selected mode (for example, a prediction mode) and a motion vector, to reduce a bit rate. Statistical coding is a lossless coding scheme that can effectively reduce a bit rate required for expressing the same signal. Statistical coding may include, but is not limited to: variable length coding (VLC) or content adaptive binary arithmetic coding (CABAC).
5) Loop filtering: A series of operations of inverse quantization, inverse transform, and predictive compensation (that is, reverse operations of the foregoing (2) to (4)) are performed on an image that has been coded based on the foregoing operations, to obtain a reconstructed decoded image (or referred to as a reconstructed image). Compared with the original image, in the reconstructed image, some information may be different from that in the original image due to the impact of quantization, causing distortion. Therefore, a filtering operation can be performed on the reconstructed image by using a filter, so that a degree of distortion caused by quantization can be effectively reduced. The filter may include, but is not limited to: a deblocking filter (DF), sample adaptive offset (SAO), an adaptive loop filter (ALF), or the like. Because these filtered reconstructed images may be used as reference information for subsequent to-be-coded images to predict future signals, the filtering operation is also referred to as loop filtering, that is, a filtering operation in a coding loop.

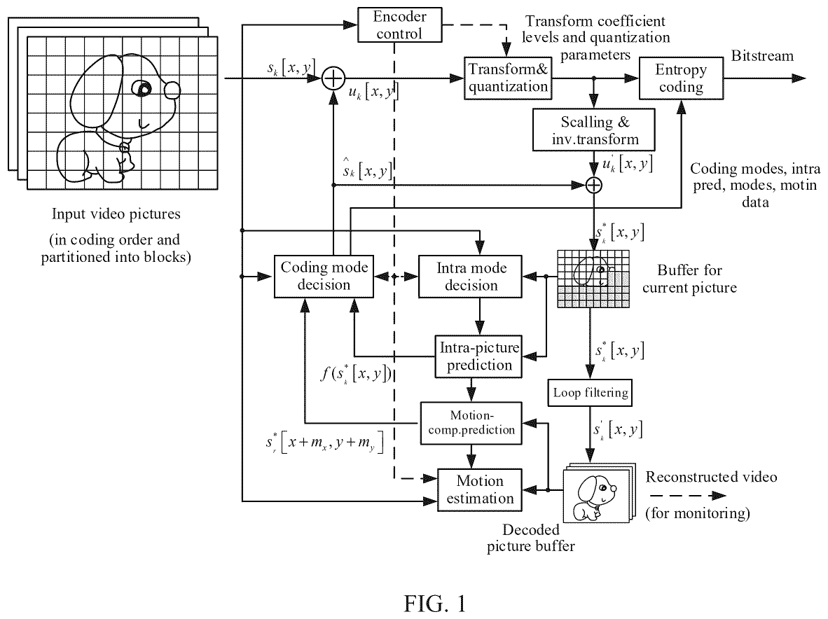

A basic process (that is, operations (1) to (5)) of video coding is described below with reference to the video coder shown in FIG. 1. In FIG. 1, for example, a to-be-coded current coding block is a k^{th} CU (sₖ [x, y] shown in FIG. 1) in a current image frame, where k is a positive integer, and k is less than or equal to a total quantity of CUs included in the current image frame. sₖ [x, y] represents a pixel with coordinates [x, y] in the k^{th} CU, where x represents a horizontal coordinate of the pixel, and y represents a vertical coordinate of the pixel. A predicted signal ŝₖ [x, y] may be obtained by performing processing such as motion compensation or intra-frame prediction on sₖ [x, y]. A difference operation may be performed on the predicted signal ŝₖ [x, y] and the original signal sₖ [x, y] to obtain a residual video signal uₖ [x, y]. Then, the residual video signal uₖ [x, y] is transformed and quantized to obtain quantized data. Data outputted through quantization has two data flow directions:

Data flow direction 1: A coding end can send, to an entropy coder for entropy coding, the data outputted through quantization, to obtain a coded bitstream, and the bitstream is outputted to a buffer for storage and is to be transmitted to a decoding end. After the decoding end receives the bitstream, for each CU unit, on one hand, the decoding end may perform entropy decoding on the bitstream, to obtain various mode information and a quantized transform coefficient of the current CU unit. The decoding end performs inverse quantization and inverse transform on each coefficient to obtain a residual signal. On the other hand, the decoding end can obtain, based on known mode information of the coding side, a predicted signal corresponding to the current CU unit. In this way, the decoding end adds the residual signal and the predicted signal to obtain a reconstructed signal, and performs a loop filtering operation on a reconstructed value (or the reconstructed signal) of the decoded image, to generate a final output signal.

Data flow direction 2: The coding end may perform inverse quantization and inverse transform on data outputted through quantization, to obtain a residual video signal uₖ′[x, y] after the inverse transform. The coding end adds the residual video signal uₖ′[x, y] after the inverse transform and the predicted signal ŝₖ [x, y] to obtain a new predicted signal sₖ*[x, y], and sends the new predicted signal sₖ*[x, y] to a buffer of a current image for storage. In this way, the coding end performs intra-frame prediction processing on the new predicted signal sₖ*[x, y] to obtain f(sₖ*[x, y]), then performs loop filtering processing on the new predicted signal sₖ*[x, y] to obtain a reconstructed signal sₖ′[x, y], and sends the reconstructed signal sₖ′[x, y] to a buffer of a decoded image for storage to generate a reconstructed video. Motion compensation prediction processing is performed on the reconstructed signal sₖ′([x, y] to obtain sᵣ*[x+mₓ, y+m_{y}], where sᵣ*[x+mₓ, y+m_{y}] may indicate a reference block, and mₓ and m_{y} respectively represent a horizontal component and a vertical component of a motion vector of the reference block.

### 2. Color Coding

An image is formed by pixels. A pixel in an image may be simply understood as a square with a fixed color value in the image, and a plane formed by a plurality of squares in rows and columns is the image. A resolution of an image may be represented by quantities of pixels included in a row and a column of the image. For example, if a resolution of an image is 1920×1280, it indicates that each row of the image includes 1920 pixels, and each column includes 1280 pixels. Pixels need to carry colors to obtain a colorful image. In a computer system, various colors may be obtained through changes of red, green, and blue (RGB) color channels and mutual superimposing.

Because an RGB signal is not conducive to compression, in a video coding technology, the RGB signal needs to be converted into a YUV signal for compression, to save video coding resources. YUV is a digital color representation and specifically refers to a pixel format in which a luminance component and a chrominance component are separately represented. “Y” represents luminance or luma, that is, a grayscale value. “U” and “V” represent chrominance and function to describe an image color and saturation and specify a pixel color. Compared with the RGB signal, coding and transmission of the YUV signal only need to occupy a very small bandwidth (RGB requires simultaneous transmission of three independent video signals). “Luminance” is established by using an RGB input signal, and specifically particular parts of the RGB signal are superimposed. “Chrominance” defines two aspects of a color: hue and saturation, which are respectively represented by Cr and Cb. Cr indicates a difference between red of an RGB input signal and a luminance value of the RGB signal, and Cb indicates a difference between blue of the RGB input signal and the luminance value of the RGB signal. The YUV color format is important because the luminance signal Y and the chrominance signals U and V are separated. If an image includes only the Y component (a luminance component) and does not include the U and V components (chrominance components), the image is a black-and-white grayscale image.

Further, storage formats of the three components of YUV are closely related to sampling manners (or referred to as sampling formats). Mainstream YUV sampling manners mainly include the following three types: YUV4:4:4, YUV4:2:2, and YUV4:2:0. The symbol “A:B:C” is configured for describing sampling frequencies of U and V relative to Y, and also indicates a resolution difference between Y:U:V to some extent. For example, YUV4:2:0 indicates that a resolution of the sampling luminance component Y is four times a resolution of the first chrominance component U or a resolution of the second chrominance component V, that is, a quantity of horizontal sampling points and a quantity of vertical sampling points of the luminance component are both two times that of the chrominance component (for example, the first chrominance component U and the second chrominance component V). Specifically, (1) YUV4:4:4 sampling represents: downsampling is not performed on the chrominance channel, that is, in this sampling manner, each Y component corresponds to one group of UV components. (2) YUV4:2:2 sampling represents: horizontal downsampling is performed according to the format 2:1, and there is no vertical downsampling. Each time one row is scanned, every two U or V samples include four Y samples. That is, in this sampling manner, every two Y components share one group of UV components. (3) YUV4:2:0 sampling represents: horizontal downsampling is performed according to the format 2:1, and vertical downsampling is performed according to the format 2:1, that is, in this sampling manner, every four Y components share one group of UV components.

Based on the foregoing related description of basic content such as the video coding format and the YUV color representation, an embodiment of this application provides an image processing solution. The image processing solution is specifically an intra-frame prediction solution, and is specifically a cross-component prediction solution of intra-frame prediction. A basic procedure of the image processing solution is as follows:

Coding end: when performing coding processing on a current image (for example, a separate image or a video frame in a video), a coding end may determine a to-be-coded current coding block in the current image. A first component of the current coding block has been reconstructed, and a second component is a to-be-predicted component. Then, a cross-component prediction model of the current coding block is obtained. The cross-component prediction model may be generated online or offline. This is not limited. The cross-component prediction model is constructed according to reconstructed pixels in the current image, and the cross-component prediction model may be used to indicate a mapping relationship between a first component and a second component of the current coding block. Then, the coding end performs cross-component prediction on the current coding block based on a reconstructed value of the first component of the current coding block and the mapping relationship indicated by the cross-component prediction model, to obtain a predicted value of the second component of the current coding block. That is, the reconstructed value of the first component of the current coding block is inputted to the cross-component prediction model, so that the cross-component prediction model calculates or deduces the predicted value of the second component of the current coding block based on the reconstructed value of the first component and the mapping relationship indicated by the cross-component prediction model. The coding end codes the current coding block based on the predicted value of the second component of the current coding block, to generate an image bitstream.

Corresponding decoding end: After obtaining the image bitstream sent by the coding end, a decoding end determines the to-be-decoded current coding block from the image bitstream. A current image to which the current coding block belongs includes reconstructed pixels, and the first component of the current coding block has been reconstructed but the second component is not reconstructed (that is, the second component is the to-be-predicted component). In this case, the decoding end obtains the cross-component prediction model of the current coding block. The cross-component prediction model is constructed according to reconstructed pixels in the current image, and the cross-component prediction model is used to indicate a mapping relationship between the first component and the second component of current coding block. In this way, the decoding end performs cross-component prediction on the current coding block based on the reconstructed value of the first component of the current coding block and the mapping relationship indicated by the cross-component prediction model, to obtain the predicted value of the second component of the current coding block, and then can reconstruct a reconstructed image of the current coding block based on the predicted value of the second component.

The first component and the second component provided in this embodiment of this application may be luminance components or chrominance components. The first component and the second component of the current coding block may have any one of the following forms: (1) The first component is a luminance component Y, and the second component is a first chrominance component U. In this case, the first chrominance component U may be predicted according to the luminance component Y of the reconstructed pixels. (2) The first component is a luminance component Y, and the second component is a second chrominance component V. In this case, the second chrominance component V may be predicted according to the luminance component Y of the reconstructed pixels. (3) The first component is a first chrominance component U, and the second component is a second chrominance component V. In this case, the second chrominance component V may be predicted according to the first chrominance component U of the reconstructed pixels. (4) The first component is a luminance component and a first chrominance component YU, and the second component is a second chrominance component V. In this case, the second chrominance component V may be predicted according to the luminance component and the first chrominance component YU of the reconstructed pixels. (5) The first component is a luminance component and a second chrominance component YV, and the second component is a first chrominance component U. In this case, the first chrominance component U may be predicted according to the luminance component and a second chrominance component YV of the reconstructed pixels.

Component types of the first component and the second component are not limited in this embodiment of this application. For example, alternatively, the first component may be the second chrominance component V and the second component may be the first chrominance component U. In this case, the first chrominance component U of to-be-predicted pixels may be predicted according to the second chrominance component V of the reconstructed pixels. For ease of description below, it is indicated herein that the first component is, for example, the luminance component Y and the second component is the first chrominance component U.

As can be seen, on one hand, in this embodiment of this application, intra-frame prediction is implemented through cross-component prediction at coding and decoding stages. In addition, component types of the first component and the second component involved in cross-component are not limited, that is, cross-component prediction between any two components is supported, thereby effectively improving intra-frame prediction speed and efficiency. The “two components” herein are the first component and the second component. As can be known according to the foregoing related description of the first component and the second component, the first component may be a single component (for example, the luminance component Y, the first chrominance component U, or the second chrominance component V) in YUV, or may be a plurality of components (for example, the luminance component and the first chrominance component YU, or the luminance component and the second chrominance component YV) in YUV. Therefore, from the perspective of YUV, this embodiment of this application supports predicting a component based on one or more components in YUV, thereby diversifying cross-component prediction and improving intra-frame prediction efficiency.

On the other hand, in the cross-component prediction solution provided in this embodiment of this application, a new cross-component prediction model is constructed based on similarity between mapping relationships between different components of reconstructed pixels, and the reconstructed image of the current coding block is generated based on the cross-component prediction model and the reconstructed component (for example, the first component) of the current coding block. Compared with a conventional intra-frame prediction method, in this embodiment of this application, a more refined cross-component prediction model is constructed based on reconstructed pixels. In this way, higher-quality predicted pixels of the current coding block can be generated based on the refined cross-component prediction model, thereby significantly improving prediction quality and coding and decoding efficiency.

The image processing solution provided in this embodiment of this application may be applied to any product having a related video coding and decoding function or video compression function. The product herein may include an application program or a computer device.

For example, the application program may be any application having a video coding and decoding function. The application program may be a computer program that completes one or more particular tasks. When classified according to running manners of application programs, application programs may include: a client installed in a terminal, a mini program (as a subprogram of the client) that can be used without downloading and installing, a world wide web (web) application program opened through a browser, and the like. When classified according to function types of application programs, application programs may include but are not limited to: an instant messaging (IM) application program, a content interaction application program, and the like. The instant messaging application program refers to an Internet-based application program for instant messaging and social interaction. The instant messaging application program may include, but is not limited to: a social application program including a communication function, a map application program including a social interaction function, a game application program, and the like. The content interaction application program refers to an application program that can implement content interaction, and may be, for example, an application program such as an online bank, a sharing platform, a personal space, or news.

For another example, the computer device may be a physical device having a video coding and decoding capability. The device may include a terminal or a server. The terminal may include, but is not limited to: a terminal device such as a smartphone (for example, a smartphone deployed with an Android system or a smartphone deployed with an internetworking operating system (IOS)), a tablet computer, a portable personal computer, a mobile Internet device (MID), a vehicle-mounted device, a head-mounted device, and the like. Types of terminal devices are not limited in the embodiments of this application. This is indicated herein. The server may be an independent physical server, or may be a server cluster or a distributed system formed by a plurality of physical servers, or may be a cloud server that provides basic cloud computing services such as a cloud service, a cloud database, cloud computing, a cloud function, cloud storage, a network service, cloud communication, a middleware service, a domain name service, a security service, a content delivery network (CDN), big data, and an artificial intelligence platform. The terminal device and the server may be connected directly or indirectly in a wired communication manner or a wireless communication manner. This is not limited in this application.

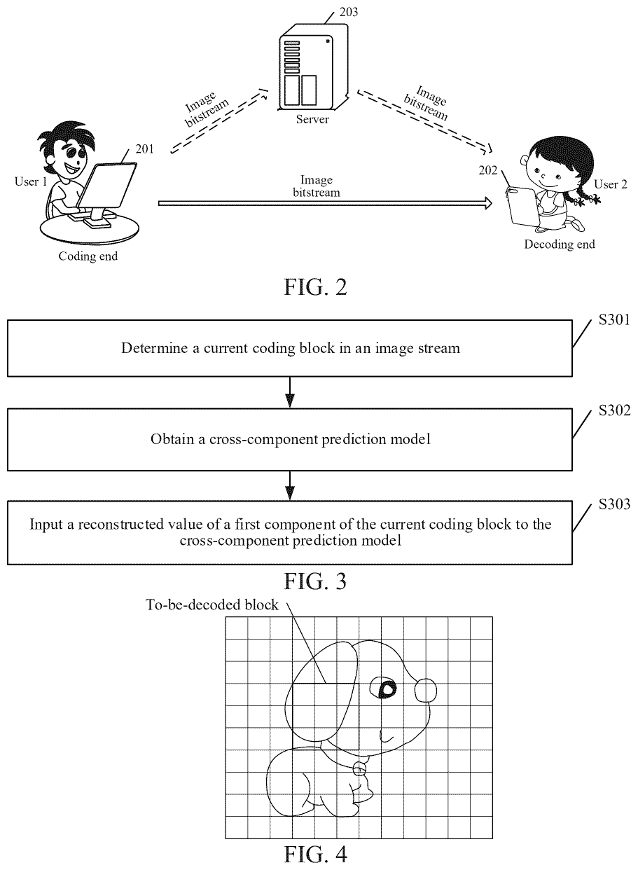

The foregoing only briefly describes a product form to which the image processing solution provided in the embodiments of this application may be applied. In an actual application, a product to which the image processing solution may be applied is not limited in this embodiment of this application. For example, the image processing solution provided in the embodiments of this application can also be deployed in an application program or a computer device in a form of plugin. For ease of description below, the image processing solution is deployed, for example, in a computer device, that is, the computer device uses the image processing solution to perform video coding and decoding. This is specifically indicated herein. For example, the image processing solution provided in the embodiments of this application is deployed in a social application program. Besides, when the social application program runs in a terminal, a schematic diagram of a video coding and decoding scenario may be shown in FIG. 2. As shown in FIG. 2, assuming that when a user 1 and a user 2 perform a social session by using a social application program, the user 1 needs to send a video (or an image) to the user 2, and the user 1 uses a social application program in a terminal 201 to send the video to the same social application program in a terminal 202 of the user 2. In this way, the user 2 opens and plays, by using the social application program of the user, the video sent by the user 1. In the foregoing process, the user 1 serves as a sender of the video, and the terminal 201 (which may be specifically a social application program deployed on the terminal 201) of the user may serve as a coding end. The user 2 serves as a receiver of the video, and the terminal 202 (which may be specifically a social application program deployed on the terminal 202) of the user may serve as a decoding end.

In a video coding process, the terminal 201 performs video coding on a to-be-transmitted video. Specifically, the terminal divides each video frame in the video into a plurality of coding blocks, and codes (including the process in operations (2) to (5) in the foregoing video coding technology, for example, an operation such as predictive coding, transform, quantization, entropy coding, and loop filtering) different coding blocks according to a coding sequence of each video frame in the video and coding sequences of the different coding blocks in the same video frame, to generate a coded stream (or referred to as an image bitstream). In a process of performing predictive coding on a coding block, the current coding block needs to be predicted by using the cross-component prediction solution provided in the embodiments of this application, to obtain a predicted image of the current coding block. Then, calculation is performed on the predicted image and a real image (that is, an image before coding, such as a video frame) of the current coding block, to obtain residual information of the current coding block, and operations such as transform, quantization, and entropy coding continue to be performed on the residual information, to generate a coded bitstream. Correspondingly, in a video decoding process, the terminal 202 decodes the received coded bitstream. A decoding process may be considered as a reverse process of the coding process, and aims to recover the original video. The reverse process on the decoding side is not described herein again. As can be seen, at a predictive coding stage of the video coding process, prediction is performed by using the refined cross-component prediction model provided in the embodiments of this application, so that prediction quality of the current coding block can be effectively ensured, thereby ensuring video coding quality and efficiency.
(1) Block division information and mode information or parameter information (such as a model parameter of the cross-component prediction model or information such as a template selection manner) in prediction, transform, quantization, entropy coding, loop filtering, and the like determined by the coding end are carried in the coded bitstream when necessary. In this way, the decoding end performs parsing based on the coded bitstream and performs analysis according to existing information, to determine block division information and mode information or parameter information in prediction, transform, quantization, entropy coding, loop filtering, and the like that are the same as those of the coding end, to ensure that the real image coded by the coding end is the same as the decoded image obtained by the decoding end through decoding. According to different processes of compressing the mode information or the parameter information by the coding end during coding, the parsing, by the decoding end, the mode information or the parameter information based on the coded bitstream may include, but is not limited to, two manners: In some embodiments, the mode information or the parameter information may be directly obtained by parsing bits in the coded bitstream. For example, when a value of a parameter defined in the coded bitstream is 1, a template region 1 is selected, and when the value is 0, a template region 2 is selected. In some embodiments, the mode information or the parameter information is implicitly exported from the coded bitstream. The implicitly exporting herein may be roughly understood as: a process of obtaining some intermediate parameters from the coded bitstream through parsing, performing an operation on the intermediate parameters, and exporting mode information or parameter information based on an operation result. The decoding end may parse any mode information or parameter information in either of the foregoing two manners based on the coded bitstream sent by the coding end. This is not limited.
(2) FIG. 2 is only a schematic architectural diagram of an exemplary image processing system. In actual application, the architecture may adaptively change. For example, the system further includes a server 203. The server 203 may be used as an intermediate device for interaction between the terminal 201 and the terminal 202, to implement data forwarding, caching, and the like. In addition, there may be one or more servers 203, for example, a plurality of distributed servers.
(3) In the embodiments of this application, the relevant data collection and processing need to be in strict accordance with the requirements of relevant laws and regulations, personal information acquisition requires the knowledge or consent of an individual subject (or has legal basis for information acquisition), and subsequent data usage and processing behaviors are carried out within the scope of authorization of laws and regulations and the personal information subject. When the embodiments of this application are applied to specific products or technologies, for example, when a terminal sends a video, permission or consent from an uploader or a creator of the video is required, and the collection, usage, and processing of relevant data need to comply with relevant laws, regulations, and standards of relevant regions.

Based on the foregoing related description of the image processing solution and the applicable product or scenario architecture, the following describes details of an image processing method provided in the embodiments of this application with reference to the accompanying drawings.

FIG. 3 is a schematic flowchart of an image processing method according to an exemplary embodiment of this application. The schematic flowchart shown in FIG. 3 is a schematic flowchart on a decoding side, and the process is performed by a computer device on the decoding side. The method may include, but is not limited to, operations S301 to S303.

S301: Determine a current coding block in an image bitstream.

The current coding block is any coding unit (CU) that is in a to-be-decoded current image (or a current image frame) of an image bitstream and whose second component has not been reconstructed but first component has been reconstructed. In this case, the second component of the current coding block may be determined as a to-be-predicted component. For example, the first component is a luminance component Y, and the second component is a first chrominance component U. It indicates that the luminance component of the current coding block has been decoded and reconstructed, a decoding end has obtained a reconstructed value of the luminance component, and the first chrominance component U has not been decoded. Exemplarily, for a position of the current coding block in the current image, refer to FIG. 4. The current coding block is a region including a plurality of pixels in the current image.

S302: Obtain a cross-component prediction model.

After the to-be-decoded current coding block is determined based on operation S301, prediction compensation needs to be performed on the current coding block (specifically, a current coding block on which operations such as inverse quantization and inverse transform have been performed), to obtain a predicted image of the current coding block. Then, an addition operation is performed on the predicted image of the current coding block and residual information obtained by parsing the image bitstream, to reconstruct a reconstructed image of the current coding block.

In this embodiment of this application, a new intra-frame prediction manner is provided to implement prediction compensation for the current coding block. Specifically, in this embodiment of this application, the cross-component prediction model can be obtained for the current coding block. The cross-component prediction model is constructed according to reconstructed pixels in the current image, and the cross-component prediction model may be used to indicate a mapping relationship between a first component and a second component of the current coding block. That is, in this embodiment of this application, the cross-component prediction model can be generated based on correlation between a mapping relationship between components of reconstructed pixels in the current image and a mapping relationship between components of the current coding block, to be specific, correlation between the mapping relationship between the first component and the second component of the reconstructed pixels and the mapping relationship between the first component and the second component of the current coding block and according to a template (the template includes reconstructed pixels) of a neighboring region of the current coding block. In this way, the cross-component prediction model has better prediction accuracy and better prediction performance when being used to predict the second component of the current coding block, thereby significantly improving predicted image quality and coding and decoding efficiency.

The cross-component prediction model in the embodiments of this application may be generated offline or online.
1. The cross-component prediction model is generated offline. Offline generation means: before a decoding end parses the current coding block, a model parameter of the cross-component prediction model has been calculated. In this implementation, the decoding end only needs to determine a model parameter for calculating the cross-component prediction model, and can directly construct the cross-component prediction model based on the model parameter (specifically, the model parameter is substituted to an expression of the cross-component prediction model, to obtain a cross-component prediction model in which the model parameter is known and only the first component and the second component are unknown). As can be seen, when the cross-component prediction model is generated offline, this can ensure that the generated cross-component prediction model can be quickly invoked when predicting the second component for the current coding block, thereby improving the prediction speed and efficiency of the second component of the current coding block.

Further, a manner of determining the model parameter by the decoding end may include: 1. The model parameter is preset. Specifically, the model parameter is calculated in advance and preset in the decoding end (for example, preset in a decoding protocol used by the decoding end). 2. Alternatively, the model parameter is obtained by parsing the image bitstream. Specifically, a coding end may compress, into the image bitstream, each model parameter in the expression of the cross-component prediction model constructed by the coding end. In this way, the decoding end may directly parse the image bitstream to obtain the model parameter (for example, parse bits in the image bitstream or implicitly export).
2. The cross-component prediction model is generated online. Online generation means: in a process of decoding the to-be-decoded current coding block, the decoding end constructs and calculates each model parameter in the expression of the cross-component prediction model of the current coding block online, to obtain the calculated cross-component prediction model. To ensure coding and decoding consistency, the decoding end needs to calculate each model parameter in the expression of the cross-component prediction model by using a model calculation procedure consistent with that of the coding end. Generating the cross-component prediction model of the current coding block online has the following advantage: It is ensured that the cross-component prediction model generated online highly matches with the current coding block (this is reflected in that a mapping relationship between the first component and the second component of the current coding block is more similar to a mapping relationship between the first component and the second component of reconstructed pixels in a neighboring region of the current coding block). Therefore, prediction accuracy of the second component is ensured when the second component of the current coding block is predicted by using the highly matching cross-component prediction model, thereby improving quality of the predicted image of the current coding block.

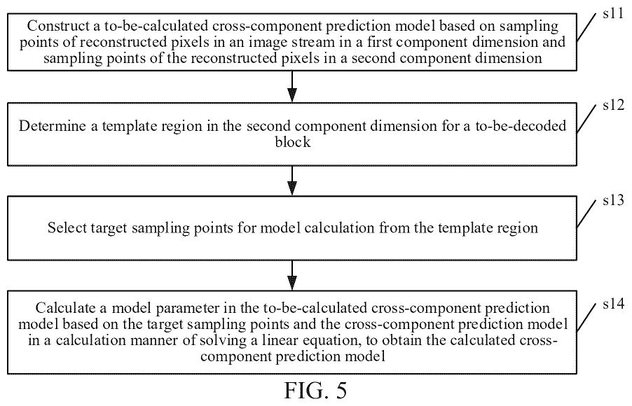

The following describes a specific implementation process of generating the cross-component prediction model corresponding to the current coding block online. As shown in FIG. 5, the model construction process may include but is not limited to operations s11 to s14.
s11: Construct an expression of the cross-component prediction model of the current coding block based on sampling points of reconstructed pixels in the image bitstream in a first component dimension and sampling points of the reconstructed pixels in a second component dimension.

In specific implementation, the decoding end may construct a plurality of cross-component matching pairs of reconstructed pixels in the image bitstream in a neighboring region of the current coding block. Specifically, the cross-component matching pairs are constructed by selecting sampling points of the reconstructed pixels in the first component dimension and sampling points of the reconstructed pixels in the second component dimension from the neighboring region of the current coding block. The neighboring region of the current coding block is a region neighboring to the current coding block in the current image. One cross-component matching pair includes one first component and one second component, the first component includes one or more sampling points, the second component includes one sampling point, and a position of a sampling point of the one or more sampling points included in the first component and a position of the sampling point included in the second component are associated positions or the same position.

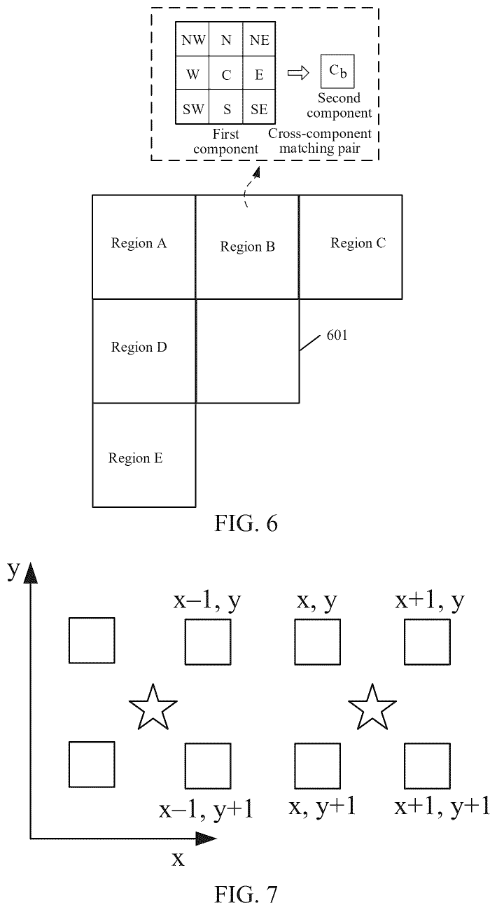

For example, a schematic diagram of a neighboring region of the current coding block and a plurality of cross-component matching pairs based on reconstructed pixels in the neighboring region may be shown in FIG. 6. As shown in FIG. 6, a plurality of neighboring regions of a to-be-decoded current coding block 601 in a current image include one of the following: a region A located on the upper left of the current coding block 601, a region B located right above the current coding block 601, a region C located on the upper right of the current coding block 601, a region D located on the left of the current coding block 601, and a region E located on the lower left of the current coding block 601. Then, sampling points in the first component dimension and sampling points in the second component dimension may be selected from the neighboring regions to construct cross-component matching pairs. For example: a sampling point Cb in the second component dimension is selected from the region B, and a sampling point C and a sampling point N, a sampling point W, a sampling point S, a sampling point E, a sampling point NW, a sampling point NE, a sampling point SW, and a sampling point SE within a spatial range of the sampling point C in the first component dimension are selected from the region B. Positions of the sampling point Cb in the second component dimension and the sampling point C in the first component dimension are associated (for example, the positions are the same or similar). Selection positions of the first component and the second component shown in FIG. 6 are merely exemplary. For example, if the second component may include more sampling points, a plurality of sampling points within a larger range may be selected for the second component.

In addition, sampling points of reconstructed pixels in the first component dimension may alternatively be obtained by preprocessing reconstructed pixels of the first component. Similarly, sampling points of reconstructed pixels in the second component dimension are obtained by preprocessing reconstructed pixels of the second component. Specifically, reconstructed pixels of the first component can be obtained, and the reconstructed pixels of the first component are preprocessed, to obtain sampling points of the reconstructed pixels of the first component in the first component dimension; and/or reconstructed pixels of the second component are obtained, and the reconstructed pixels of the second component are preprocessed, to obtain sampling points of the reconstructed pixels of the second component in the second component dimension; where a preprocessing manner of the preprocessing includes at least one of the following:
(1) Resample the first component of the current coding block when resolutions of the first component and the second component of the current coding block are different. For example, when a sampling format is YUV4:2:0, the first component is a luminance component Y, and the second component is a first chrominance component U, it is determined that the resolution of the first component is different from the resolution of the second component. In this case, the first component may be resampled before calculating the model parameter of the expression of the cross-component prediction model, so that the first component and the second component can be aligned in resolution. The resampling may be simply understood as a process of resampling sampled discrete data.

For example, as shown in FIG. 7, the first component is a luminance component and the second component is a first chrominance component. A box (the shape of box is merely an example) shown in FIG. 7 indicates original luminance of a sampling point in a luminance component dimension, for example, original luminance L(x−1, y), L(x, y), L (x+1,y), L(x−1,y+1), L(x,y+1), and L (x+1,y+1). x and y represent horizontal and vertical coordinates of the sampling point. A five-pointed star (the shape of five-pointed star is merely an example) shown in FIG. 7 indicates chrominance C (x, y) of a sampling point in a first chrominance component dimension. If the sampling format is YUV4:2:0, it is determined that the resolution of the original luminance is twice that of the chrominance in both the horizontal direction (that is, the x direction) and the vertical direction (that is, the y direction). Therefore, the original luminance needs to be downsampled. Downsampled luminance may be expressed as: L′ (x, y)=(L(x−1,y)+2L(x,y)+L (x+1,y)+L(x−1,y+1)+2L(x,y+1)+L (x+1,y+1))/8. Besides, the downsampled luminance L′ (x, y) corresponds to the chrominance C (x, y), and specifically positions of the luminance and the chrominance are associated (for example, the positions are the same or similar).

In addition, if one or more sampling points in the luminance component dimension are unusable, in a downsampling process, a luminance value of original luminance of another usable sampling point close to the one or more sampling points may be assigned to the original luminance of the one or more sampling points for downsampling. For example, if the original luminance L(x−1, y) is unusable, a luminance value of neighboring original luminance L(x, y) may be assigned to the original luminance L(x−1, y), so that the original luminance L(x−1, y) participates in downsampling. For another example, if the original luminance L(x−1, y+1) is unusable, a luminance value of neighboring original luminance L(x, y+1) may be assigned to the original luminance L(x−1,y+1), so that the original luminance L(x−1,y+1) continues to participate in downsampling.
(2) Trigger to perform the operation of constructing a plurality of cross-component matching pairs of reconstructed pixels in the image bitstream when the resolutions of the first component and the second component of the current coding block are different. That is, when the resolutions of the first component and the second component of the current coding block are different, the resampling process may not be performed, and instead model calculation is directly performed or the first component is filtered.
(3) Filter the first component of the current coding block by using one or more filters. Specifically, when the resolutions of the first component and the second component of the current coding block are different, the first component is filtered before the model calculation. Alternatively, regardless of whether resolutions of the first component and the second component of the current coding block are the same, a plurality of filters may simultaneously perform filtering preprocessing on the first component. In this way, before the model calculation, target sampling points may be selected for the model calculation from different filtering preprocessing results obtained after processing of the different filters.

In conclusion, before constructing the plurality of cross-component matching pairs of the reconstructed pixels in the image bitstream, the preprocessing performed by the decoding end on the reconstructed pixels may include: resampling the first component when resolutions of the first component and the second component are different; triggering to perform the operation of constructing a plurality of cross-component matching pairs of reconstructed pixels in the image bitstream when the resolutions of the first component and the second component are different; and filtering the first component by using one or more filters. In this way, the reconstructed pixels are differently preprocessed in different preprocessing manners based on difference between resolutions of the first component and the second component, so that quality of sampling points of the reconstructed pixels in the first component dimension and the second component dimension can be improved. Therefore, better cross-component matching pairs can be constructed based on the sampling points of the preprocessed reconstructed pixels in the first component dimension and the second component dimension, and a more refined cross-component prediction model is constructed based on the better cross-component matching pairs.

The decoding end further needs to determine a target prediction manner, to generate a target prediction mode according to the target prediction manner. The target prediction manner is used to indicate: selecting one prediction mode from Q prediction modes as the target prediction mode of the current coding block, or selecting at least two prediction modes from the Q prediction modes for weighting processing to obtain the target prediction mode of the current coding block, where Q is an integer greater than or equal to 1. The target prediction mode obtained according to the target prediction manner may be understood as an expression of an equation. The equation merely represents a mapping relationship between a sampling point in the first component dimension and a sampling point in the second component dimension, and does not include specific values of components.

Specifically, the target prediction manner may be obtained by parsing the image bitstream. When learning by parsing the image bitstream that the target prediction manner indicates selecting one or more prediction modes from the Q prediction modes as the target prediction mode of the current coding block to construct the cross-component prediction model of the current coding block, the decoding end selects the one or more prediction modes from the Q prediction modes as indicated by the target prediction manner. A specific selection rule (for example, which one or more prediction modes are selected from the Q prediction modes) may be obtained by parsing the image bitstream.

The prediction mode may be represented as an expression, and the expression is an equation. The constructing the prediction mode provided in this embodiment of this application may include: constructing the prediction mode based on the mapping relationship between the first component and the second component, the sampling points of the reconstructed pixels in the image bitstream in the first component dimension, and the sampling points of the reconstructed pixels in the image bitstream in the second component dimension. The mapping relationship between the first component and the second component may be referred to as a cross-component mapping relationship, and specifically refers to a conversion or correspondence manner between the first component and the second component. The conversion or correspondence manner may be represented in a form of equation. For example, when a luminance component of an image (or a coding block) is known, the luminance component is substituted to an equation that represents a mapping relationship between the luminance component and the chrominance component, so that the chrominance component of the image (or the coding block) may be deduced or calculated. In this way, the sampling points of the reconstructed pixels in the first component dimension and the sampling points of the reconstructed pixels in the second component dimension in the image bitstream are substituted to the equation representing the mapping relationship between the first component and the second component, to construct the prediction mode.

An order of the constructed prediction mode is the first order or a higher order. For example, the cross-component matching pair shown in FIG. 6 includes sampling points in the first component dimension and sampling points in the second component dimension, and the prediction mode may include, but is not limited to:

$${C}_{b} = {p}_{0} C + {p}_{1} N + {p}_{2} S + {p}_{3} W + {p}_{4} E + {p}_{5} {C}^{2} + {p}_{6} B \qquad a )$$

$${C}_{b} = {p}_{0} C + {p}_{1} N + {p}_{2} S + {p}_{3} W + {p}_{4} E + {p}_{5} B \qquad b )$$

$${C}_{b} = {p}_{0} C + {p}_{1} B \qquad c )$$

$${C}_{b} = {p}_{0} C + {p}_{1} ( \frac{N + S}{2} ) + {p}_{2} ( \frac{W + E}{2} ) + {{p}_{3} ( \frac{N + S}{2} )}^{2} + {{p}_{4} ( \frac{W + E}{2} )}^{2} + {p}_{5} {C}^{2} + {p}_{6} B \qquad d )$$

$${C}_{b} = {p}_{0} C + {p}_{1} ( \frac{N + S}{2} ) + {p}_{2} ( \frac{W + E}{2} ) + {{p}_{3} ( \frac{N + S}{2} )}^{2} + {{p}_{4} ( \frac{W + E}{2} )}^{2} + {p}_{5} ( \frac{N + S}{2} ) ( \frac{W + E}{2} ) + {p}_{6} B \qquad e )$$

$${C}_{b} = {p}_{0} C + {p}_{1} ( \frac{N + S}{2} ) + {p}_{2} ( \frac{W + E}{2} ) + {p}_{3} ( \frac{N W + S E}{2} ) + {p}_{4} ( \frac{N E + S W}{2} ) + {p}_{5} {C}^{2} + {p}_{6} B \qquad f )$$

$${C}_{b} = {p}_{0} C + {p}_{1} ( \frac{N + S}{2} ) + {p}_{2} ( \frac{W + E}{2} ) + {p}_{3} ( \frac{N W + S E}{2} ) + {p}_{4} ( \frac{N E + S W}{2} ) + {p}_{5} ( \frac{N + S}{2} ) ( \frac{W + E}{2} ) + {p}_{6} B \qquad g )$$

$${C}_{b} = {p}_{0} C + {p}_{1} ( \frac{N + S}{2} ) + {p}_{2} ( \frac{W + E}{2} ) + {p}_{3} ( \frac{N W + S E}{2} ) + {p}_{4} ( \frac{N E + S W}{2} ) + {p}_{5} B \qquad h )$$

$${C}_{b} = {p}_{0} ( \frac{N + S + W + E}{4} ) + {p}_{1} ( \frac{N + W}{2} ) + {p}_{2} ( \frac{N + E}{2} ) + {p}_{3} ( \frac{S + W}{2} ) + {p}_{4} ( \frac{S + E}{2} ) + {{p}_{5} ( \frac{N + S + W + E}{4} )}^{2} + {p}_{6} B \qquad i )$$

$${C}_{b} = {p}_{0} ( \frac{N + S + 4 C + W + E}{8} ) + {p}_{1} ( \frac{N + W}{2} ) + {p}_{2} ( \frac{N + E}{2} ) + {p}_{3} ( \frac{S + W}{2} ) + {p}_{4} ( \frac{S + E}{2} ) + {{p}_{5} ( \frac{N + S + 4 C + W + E}{8} )}^{2} + {p}_{6} B \qquad j )$$

$${C}_{b} = {p}_{0} C + {p}_{1} ( \frac{N + W}{2} ) + {p}_{2} ( \frac{N + E}{2} ) + {p}_{3} ( \frac{S + W}{2} ) + {p}_{4} ( \frac{S + E}{2} ) + {p}_{5} {C}^{2} + {p}_{6} B \qquad k )$$

The sampling point N, the sampling point S, the sampling point C, the sampling point E, and the sampling point W in the prediction mode are sampling points included in the first component in the cross-component matching pair shown in FIG. 6. The sampling point C_{b} is a sampling point in the second component in the cross-component matching pair shown in the FIG. 6, and a position of the sampling point C and a position of the sampling point C_{b} are associated positions or the same position. B is a constant bias term, and the constant bias term may be determined according to a sampling bit depth or a calculation bit depth. For example, it is set that 1<< (bit depth-1), and when the bit depth is 10, B is 512. p₀, p₁, p₂, p₃, p₄, p₅, and p₆ are model parameters.

The foregoing several prediction modes are merely examples and do not limit this embodiment of this application. In an actual application process, prediction modes of more forms may be further constructed.

In addition, as can be known from the exemplary prediction mode, the constructed prediction mode includes at least one monomial and a coefficient of each of the at least one monomial.
(1) The monomial includes at least one of the following: a constant term and a sampling point term that is constructed by at least one sampling point in the first component. A manner of constructing the sampling point term includes one or more of the following: a single sampling point, an m1^{th}-order of a single sampling point, a multiple of a single sampling point, an operation formula formed by at least two sampling points, an m1^{th}-order of an operation formula formed by at least two sampling points, and an operation formula formed by an m3^{th}-order of some sampling points of at least two sampling points and a remaining sampling point of the at least two sampling points, where m1, m2, and m3 are the same or different and m1, m2, and m3 are non-zero real numbers. For example, the monomial may include but is not limited to at least one of the following: x, y, mx±ny, xy, x^{k}, (mx±ny)^{k}, (mx±ny) (pz±qf), (mx±ny) x, and the constant bias term B. The monomial may alternatively be a multiplication combination of the monomial examples. For example, the monomial may be x(mx±ny) and y(mx±ny). A form of the monomial is not limited in this embodiment of this application. In the monomial, m, n, p, and q are non-zero integers, x and y are fixed weights, and k is an order and is a non-zero real number.

The operation formula formed by at least two sampling points includes: (1) Linear weighting of at least two sampling points. For example, the at least two sampling points include sampling points X1, X2, and X3, and then linear weighting of the at least two sampling points is expressed as: p₀X1+p₁X2+p₂X3, where p₀, p₁, and p₂ are weight values of linear weighting. (2) Square of linear weighting of at least two sampling points. For example, the at least two sampling points include sampling points X1, X2, and X3, and then the square of linear weighting of the at least two sampling points is expressed as: (p₀X1+p₁X2+p₂X3)². Certainly, in this embodiment of this application, a quantity of sampling points of linear weighting and an order of linear weighting of at least two sampling points are not limited. (3) Linear weighting of at least two sampling points raised to a power n1. (4) A product of weighting of at least two sampling points raised to a power n1 and weighting of other at least two sampling points raised to a power n2. (5) A product of weighting of at least two sampling points raised to a power n3 and one sampling point raised to a power of n4. n1, n2, n3, and n4 are non-zero real numbers, and may be 1, 2, or the like.
(2) The coefficient of each of the at least one monomial, as a model parameter, is obtained by parsing the image bitstream or calculated based on the model.

Further, after the decoding end determines a target prediction mode (which is, for example, one of the Q prediction modes or obtained by weighting at least two prediction modes) from the Q prediction modes based on the target prediction manner, the decoding end further generates a prediction sub-equation for each of the plurality of constructed cross-component matching pairs according to the target prediction mode. That is, a quantity of the constructed cross-component matching pairs is the same as a quantity of prediction sub-equations included in the expression of the cross-component prediction model. One prediction sub-equation corresponds to one cross-component matching pair.
s12: Determine a template region in the second component dimension for the current coding block.

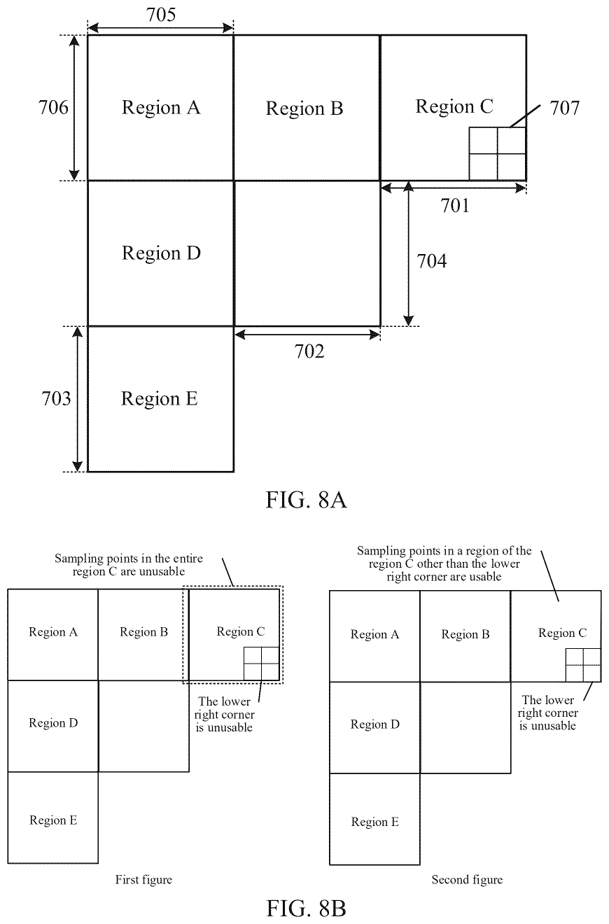

After the decoding end selects the expression (for example, the expression is a plurality of prediction sub-equations) of the cross-component prediction model for the current coding block based on operation s11, the decoding end needs to determine the template region in the second component dimension for the current coding block, to subsequently select target sampling points from the template region for model calculation. During specific implementation, the decoding end may first determine a plurality of neighboring regions of the current coding block in the second component dimension. The neighboring region is a region neighboring/close to the current coding block in the second component dimension. For example, a plurality of neighboring regions of the current coding block in the second component dimension may be a region A, a region B, a region C, a region D, and a region E shown in FIG. 6. The decoding end needs to determine the template region for the current coding block from the plurality of neighboring regions of the current coding block in the second component dimension, and specifically selects a neighboring region from the plurality of neighboring regions as the template region of the current coding block. The following describes a size relationship between the plurality of neighboring regions of the current coding block with reference to FIG. 8A. As shown in FIG. 8A, a horizontal size 801 of the region C is the same as a horizontal size 802 of the current coding block, and a vertical size 803 of the region E is the same as a vertical size 804 of the current coding block, a horizontal size 805 and a vertical size 806 of the region A are the same, vertical sizes of the region A, the region B, and the region C are the same, and horizontal sizes of the region A, the region D, and the region E are the same. Vertical sizes of the region A, the region B, and the region C are equal to horizontal sizes of the region A, the region D, and the region E. For example, specific values of the vertical size and the horizontal size may be preset (for example, a preset value is 6 or another integer), or may be obtained by parsing the image bitstream.

Not all the plurality of neighboring regions of the current coding block may be usable, that is, not all sampling points in the plurality of neighboring regions may be configured for model calculation. Specifically, it is assumed that any of the plurality of neighboring regions of the current coding block represents a target region. When a second component in a target sub-region within the target region is not reconstructed or the target sub-region within the target region extends beyond boundary of the image, it is determined that the target region is unusable. Specifically, all or some sampling points within the target region cannot be used for model parameter calculation. According to different target regions, target sub-regions within the target regions may be different. For example, when the target region is the region C or the region E, the target sub-region within the target region may be a sub-region at a lower right corner of the target region (for example, a sub-region 808 at a lower right corner of the region C shown in FIG. 8A). Further, the target region being unusable may specifically include any one of the following:
1) All sampling points included in the target region are unusable. In a first figure shown in FIG. 8B, a sampling point at the lower right corner of the region C is not reconstructed. It indicates that the sampling point at the lower right corner is unusable. Therefore, it is determined that the entire region C is unusable. Alternatively, an unusable sampling point included in the target region is unusable.
2) An unusable sampling point included in the target region is unusable. In a second figure shown in FIG. 8B, a sampling point at the lower right corner of the region C is not reconstructed. It indicates that the sampling point at the lower right corner is unusable. Therefore, the sampling point at the lower right corner is not used, but other usable sampling points outside the lower right corner in the region C can still be used.

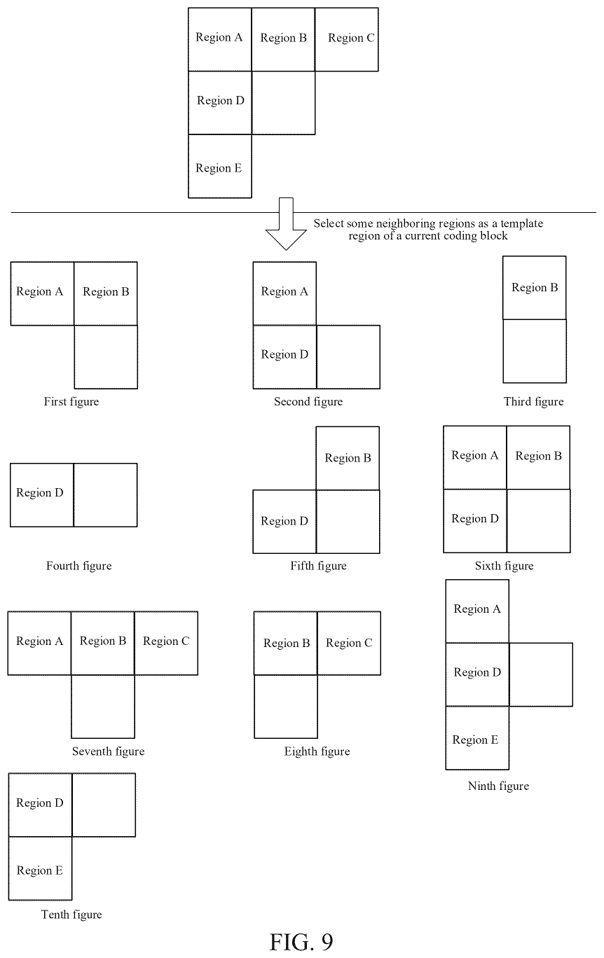

Further, based on the related descriptions of the plurality of neighboring regions of the current coding block, a manner of selecting the template region of the current coding block from the plurality of neighboring regions of the current coding block in the second component dimension may include at least one of the following:
1) Use all the plurality of neighboring regions of the current coding block in the second component dimension as the template region of the current coding block. As shown in FIG. 8A, the plurality of neighboring regions of the current coding block are the region A, the region B, the region C, the region D, and the region E, and the region A, the region B, the region C, the region D, and the region E may all be used as the template region of the current coding block.
2) Use some of the plurality of neighboring regions of the current coding block in the second component dimension as the template region of the current coding block. For example, it is assumed that the plurality of neighboring regions of the current coding block are respectively: the region A, the region B, the region C, the region D, and the region E. In this case, at least one of these neighboring regions may be used as the template region of the current coding block. A schematic diagram of selecting some of the plurality of neighboring regions of the current coding block as the template region may be shown in FIG. 9. As shown in FIG. 9, when the plurality of neighboring regions of the current coding block are respectively: the region A, the region B, the region C, the region D, and the region E, a manner of selecting some neighboring regions from the region A, the region B, the region C, the region D, and the region E as the template region may include: In a first figure shown in FIG. 9, the region A and the region B are selected as the template region of the current coding block. In a second figure shown in FIG. 9, the region A and the region D are selected as the template region of the current coding block. In a third figure shown in FIG. 9, the region B is selected as the template region of the current coding block. In a fourth figure shown in FIG. 9, the region D is selected as the template region of the current coding block. In a fifth figure shown in FIG. 9, the region B and the region D are selected as the template region of the current coding block. In a sixth figure shown in FIG. 9, the region A, the region B, and the region D are selected as the template region of the current coding block. In a seventh figure shown in FIG. 9, the region A, the region B, and the region C are selected as the template region of the current coding block. In an eighth figure shown in FIG. 9, the region B and the region C are selected as the template region of the current coding block. In a ninth figure shown in FIG. 9, the region A, the region D, and the region E are selected as the template region of the current coding block. In a tenth figure shown in FIG. 9, the region D and the region E are selected as the template region of the current coding block. Selecting some neighboring regions from the plurality of neighboring regions of the current coding block is not limited to the several exemplary manners shown in FIG. 9. For example, only the region A may be selected as the template region of the current coding block.
3) When it is stipulated or specified that the current coding block has a plurality of template regions, in this embodiment of this application, the decoding end can determine the template region for the current coding block by parsing the image bitstream. Specifically, the decoding end may obtain region indication information by parsing the image bitstream, and specifically, decode the image bitstream to obtain region indication information. The region indication information is used to indicate the template region corresponding to the current coding block. In this case, the decoding end may select, as indicated by the region indication information, the template region for the current coding block from the plurality of neighboring regions of the current coding block. For example, it is assumed that the region indication information obtained by the decoding end after parsing the image bitstream indicates: the region A and the region B are selected from the plurality of neighboring regions of the current coding block as the template region of the current coding block. In this case, the decoding end directly selects the template region according to the region indication information.
s13: Select target sampling points for model calculation from the template region in the second component dimension.

After the template region is determined for the current coding block based on operation s12, the target sampling points for calculating the model parameter in the expression of the cross-component prediction model of the current coding block may be further determined in the template region. A manner of selecting the target sampling points for model calculation from the template region in the second component dimension includes any one of the following:
1) All sampling points are used, that is, all sampling points in the template region of the current coding block are used as the target sampling points for model calculation. For example, the template region of the current coding block includes the region A, the region B, the region C, the region D, and the region E of the plurality of neighboring regions shown in FIG. 6. In this case, all sampling points in the region A, the region B, the region C, the region D, and the region E can be used for subsequent model calculation.
2) Some sampling points are used, that is, some sampling points are selected from the template region of the current coding block as the target sampling points for model calculation. A manner of selecting some sampling points from the template region of the current coding block includes any one of the following:
(1) Select sampling points according to coordinate positions of sampling points in the template region of the current coding block. Specifically, sampling points whose first coordinate positions and/or second coordinate positions satisfy a constraint condition are selected as the target sampling points from the template region of the current coding block. A direction of the first coordinate position is a horizontal direction of the template region of the current coding block, and a direction of the second coordinate position is a vertical direction of the template region of the current coding block. That the first coordinate positions and/or the second coordinate positions satisfy the constraint condition includes at least one of the following: the first coordinate positions and/or the second coordinate positions are even number positions, odd number positions, or all positions in a corresponding direction.

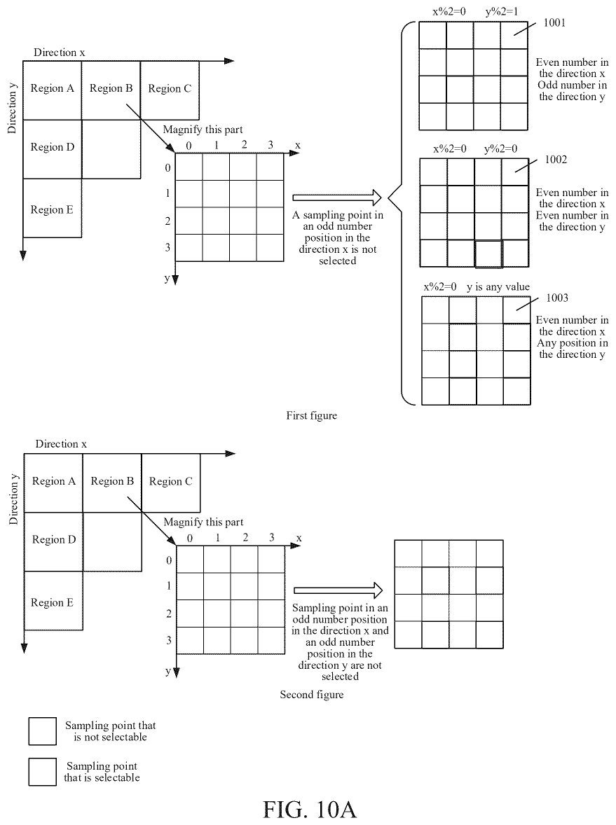

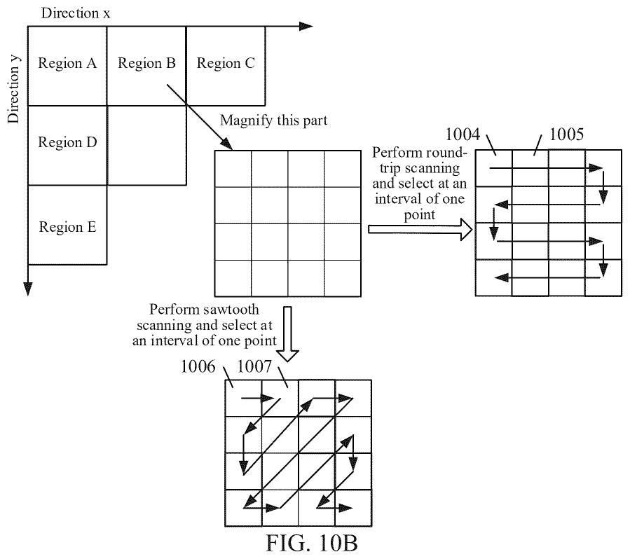

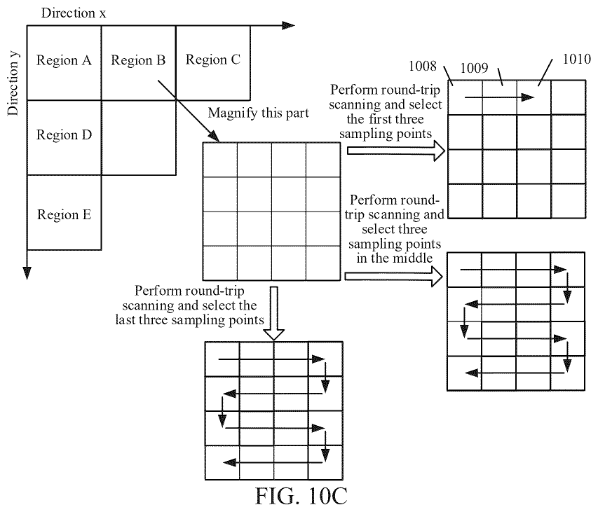

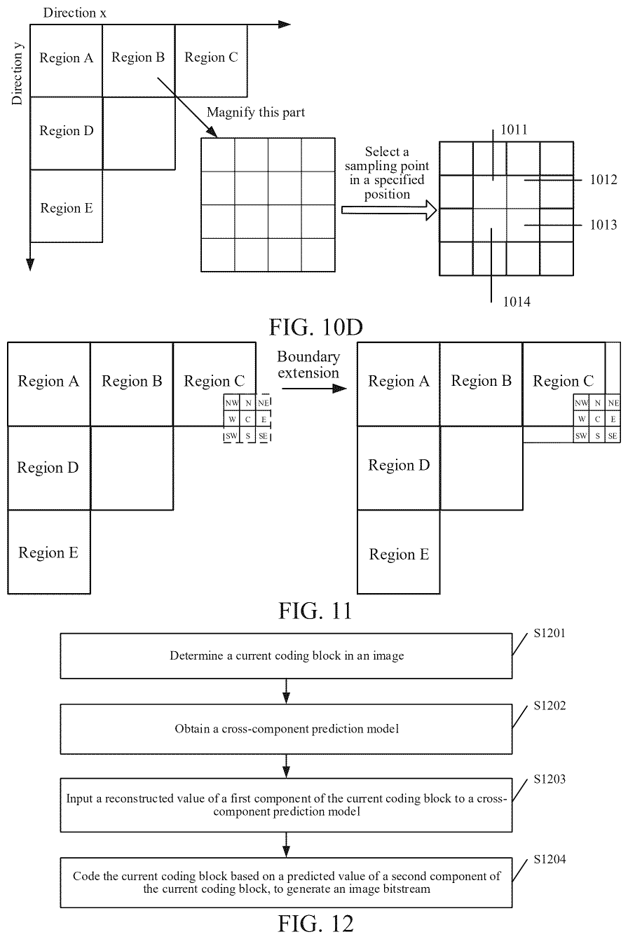

For example, assuming that an xy coordinate system is established by using an upper left corner of the region A of the plurality of neighboring regions of the current coding block as the center, sampling point coordinates of sampling points in the template region of the current coding block may include: a first coordinate position in the horizontal direction (that is, the horizontal axis x), and a second coordinate position in the vertical direction (that is, the vertical axis y). Exemplarily, in FIG. 10A, using a sampling point in any template region as an example, that a first coordinate position and/or a second coordinate position of the sampling point satisfies the constraint condition may include but is not limited to:
1) Select no sampling point whose first coordinate position in the horizontal direction is an odd number position (that is, a result of a modulo operation performed on the first coordinate position of the sampling point in the direction of the x axis and a value 2 (for example, x % 2=1) is always 1). In this case, a manner of selecting the target sampling points may be shown in the first figure shown in FIG. 10A, and includes: (1) Select a sampling point whose first coordinate position in the direction of the x-axis is an even number position (for example, a result of a modulo operation performed on a value of the sampling point in the direction of the x axis and a value 2 is always 0) and whose second coordinate position in the direction of the y-axis is an odd number position (for example, a sampling point 1001). (2) Select a sampling point whose first coordinate position in the direction of the x-axis is an even number position (for example, a result of a modulo operation performed on a value of the sampling point in the direction of the x axis and a value 2 is always 0) and whose second coordinate position in the direction of the y-axis is an even number position (for example, a sampling point 1002). (3) Select a sampling point whose first coordinate position in the direction of the x-axis is an even number position (for example, a result of a modulo operation performed on a value of the sampling point in the direction of the x axis and a value 2 is always 0) and whose second coordinate position is any position in the direction of the y-axis (for example, a sampling point 1003).
2) Select no sampling point whose first coordinate position in the horizontal direction is an odd number position and whose second coordinate position in the vertical direction is an odd number position (that is, a result of a modulo operation performed on the second coordinate position of the sampling point in the direction of the y axis and a value 2 (for example, y % 2=1) is always 1). In this case, a manner of selecting the target sampling points may be shown in the second figure shown in FIG. 10A, and includes one or more of the following: (1) Select a sampling point whose first coordinate position in the direction of the x-axis is an even number position and whose second coordinate position in the direction of the y-axis is an even number position. (2) Select a sampling point whose first coordinate position in the direction of the x-axis is an even number position and whose position in the direction of the y-axis is an odd number position. (3) Select a sampling point whose first coordinate position in the direction of the x-axis is an odd number position and whose position in the direction of the y-axis is an even number position.

The manners of selecting the target sampling points described above with reference to FIG. 10A are only several exemplary manners of selecting the target sampling points provided in this embodiment of this application, and do not limit this embodiment of this application. For example, a sampling point whose first coordinate position in the direction of the x-axis is an odd number position and whose second coordinate position in the direction of the y-axis is any position can be selected as the target sampling point.
(2) Scan the template region of the current coding block to determine target sampling points of specified coordinate positions for model calculation. Specifically, the target sampling points are selected from the template region of the current coding block in a target scanning manner. The target scanning manner includes but is not limited to: a sawtooth scanning manner (a scanning manner such as zigzag), a round-trip scanning manner, or the like. In a scanning process, a manner of selecting the target sampling points for model calculation includes at least one of the following:

First manner: selecting sampling points at intervals. For example, each time M points are scanned in a scanning process, one or more scanned points are selected as target sampling points for model calculation, where M is an integer greater than or equal to 1. As shown in FIG. 10B, assuming that a sampling point is selected as a target sampling point at an interval of one point (that is, M=1) for model calculation in the round-trip scanning manner, after a sampling point 1004 is scanned, the sampling point 1004 is not selected as the target sampling point for model calculation, and instead a next sampling point 1005 scanned in the round-trip scanning manner is used as the target sampling point for model calculation. As shown in FIG. 10B, assuming that a sampling point is selected as a target sampling point at an interval of one point (that is, M=1) for model calculation in the sawtooth scanning manner, after a sampling point 1006 is scanned, the sampling point 1006 is used as the target sampling point for model calculation, and instead a next sampling point 1007 scanned in the sawtooth scanning manner is not used as the target sampling point for model calculation.

Second manner: selecting N sampling points from the template region as the target sampling points according to a scanning sequence, where N is an integer greater than 1, the N sampling points are continuously scanned in the template region, and the N sampling points are located in a front scanning region, a middle scanning region, or a rear scanning region of the template region according to the scanning sequence. That is, in a process of scanning the template region of the current coding block, the decoding end may select N sampling points that are first scanned (the N sampling points are located in the front scanning region of the template region), or N sampling points that are scanned in the middle of scanning (the N sampling points are located in the middle scanning region of the template region), or N sampling points that are last scanned (the N sampling points are located in the rear scanning region of the template region) as the target sampling points for model calculation. For example, as shown in FIG. 10C, according to a characteristic of the cross-component prediction model (for example, a quantity of to-be-calculated model parameters included in the cross-component prediction model), only three sampling points need to be obtained through scanning to sufficiently calculate the model parameter in the expression of the cross-component prediction model. Therefore, when the template region of the current coding block is scanned in the round-trip scanning manner, three sampling points (for example, a sampling point 1008, a sampling point 1009, and a sampling point 1010) in the front scanning region are obtained through scanning according to a scanning sequence, and the three sampling points may be directly used as target sampling points for model calculation without continuing scanning.
(3) Determine whether sampling point values of sampling points in the template region of the current coding block satisfy a specified condition, to determine target sampling points for model calculation selected for the current coding block. Specifically, the decoding end may select sampling points whose sampling point values satisfy a specified condition from the template region of the current coding block; where that the sampling point values of the sampling points satisfy the specified condition at least includes: values of first components of the sampling points are greater than a value threshold or the values of the first components of the sampling points are less than or equal to a value threshold. For example, it is assumed that the first component is luminance. When a luminance value of a sampling point in the template region of the current coding block is greater than a luminance threshold, it is determined that the sampling point is selected as a target sampling point for model calculation. Alternatively, when a luminance value of a sampling point in the template region of the current coding block is less than or equal to a luminance threshold, it is determined that the sampling point is selected as a target sampling point for model calculation. A specific value of the luminance threshold is not limited.

In this embodiment of this application, a plurality of sampling points whose first components have values greater than the value threshold can also be selected from the template region of the current coding block as target sampling points, and the model parameter in the expression of the cross-component prediction model can be calculated by using the plurality of sampling points, to obtain a cross-component prediction model. In addition, a plurality of sampling points whose first components have values less than or equal to the value threshold can be selected from the template region of the current coding block as target sampling points, and the model parameter in the expression of the cross-component prediction model can be calculated by using the plurality of sampling points, to obtain a cross-component prediction model. In this way, when generating the predicted value of the second component for the current coding block, whether a luminance value of a luminance component of the current coding block is greater than the value threshold may be determined first. If a luminance value of a luminance component of the current coding block is greater than the value threshold, the second component of the current coding block is predicted by using the cross-component prediction model calculated in a model calculation stage by using sampling points whose luminance values are greater than the luminance threshold. Otherwise, if a luminance value of a luminance component of the current coding block is less than or equal to the value threshold, the second component of the current coding block is predicted by using the cross-component prediction model trained in a training stage by using sampling points whose luminance values are less than or equal to the luminance threshold. As can be seen, a plurality of cross-component prediction models are trained in different cases, and the second component is predicted during model application by using a matching cross-component prediction model. In this way, prediction accuracy of the second component can be improved to some extent.
(4) Select sampling points from a specified position or region of the template region of the current coding block as target sampling points for model calculation. Specifically, the decoding end may select sampling points from a default position of the template region of the current coding block as target sampling points for model calculation. The default position may be referred to as a specified position, and may include at least one of the following: a middle position (or another specified position or region) of the template region of the current coding block, or a neighboring position close to the current coding block in the template region of the current coding block, or the like. For example, as shown in FIG. 10D, target sampling points (for example, a sampling point 1011, a sampling point 1012, a sampling point 1013, and a sampling point 1014) in the middle of the template region of the current coding block are selected for model calculation.

The foregoing manners of selecting the target sampling points are all exemplary and are not intended to limit this embodiment of this application.

Further, before the target sampling points are selected from the template region of the current coding block for model calculation, in this embodiment of this application, boundary of the template region of the current coding block can be extended according to a characteristic of the expression of the cross-component prediction model, so that the template region whose boundary is extended better facilitates selection of the target sampling points and satisfies a requirement for solving the model parameter in the expression of the cross-component prediction model. Boundary extension specifically includes: extending boundary of the template region of the current coding block in the first component dimension according to the characteristic of the cross-component prediction model. As shown in FIG. 11, it is assumed that the template region of the current coding block is the “region C”, a sampling point S and a sampling point D within a spatial range of the sampling point C in the first component dimension need to be used, but the template region “region C” does not include the sampling point S and the sampling point D within the spatial range of the sampling point C. In this case, the template region “region C” needs to be extended by one unit, so that the extended template region “region C” can include the sampling point S and the sampling point D that need to be used. Sampling point values of sampling points in an outward extension region of the template region “region C” may be sampling point values of nearby sampling points.
s14: Calculate a model parameter in the expression of the cross-component prediction model based on the target sampling points in a calculation manner of solving a linear equation, to obtain the cross-component prediction model of the current coding block.

Based on the foregoing operations, the expression of the cross-component prediction model of the current coding block is constructed, and a plurality of target sampling points are selected for calculation of the expression of the cross-component prediction model. Therefore, the model parameter of the expression of the cross-component prediction model may be solved by using the plurality of target sampling points selected from the template region of the current coding block, to obtain a specific value of each model parameter in the expression of the cross-component prediction model. Therefore, the cross-component prediction model is obtained after model calculation. The model parameter in the cross-component prediction model is known after model calculation, an independent variable is the first component, and a dependent variable is the second component.

Specifically, the expression of the cross-component prediction model may be represented as Ax=b. A is the first component, and A is specifically a matrix having a plurality of rows and a plurality of columns. A quantity of rows of the matrix depends on a quantity of the cross-component matching pairs, and a quantity of columns of the matrix depends on a quantity of the model parameters. x is a model parameter, and x is also specifically represented as a matrix, where a quantity of rows of the matrix is a quantity of model parameters, and a quantity of columns of the matrix is 1. b is the second component, and b is also specifically a matrix. A quantity of rows of the matrix depends on a quantity of the cross-component matching pairs, and a quantity of columns of the matrix is 1. It can be seen that the model structure of the cross-component prediction model in this embodiment of this application is actually an expression, and may be specifically a matrix equation. The matrix equation includes a model parameter, an independent variable representing the first component, and a dependent variable representing the second component.

Further, a model parameter in the expression Ax=b of the cross-component prediction model may be solved by solving a linear equation, to obtain the model parameter. Therefore, the cross-component prediction model is constructed. A method for solving the expression Ax=b is not limited in this embodiment of this application, and may include, but is not limited to, an LDL decomposition method, a Gaussian elimination method, or the like. Exemplarily, a process of solving the expression Ax=b by using the LDL decomposition method may roughly include:
(1) Multiply both sides of the equation by transpose of a matrix A, to obtain A^{T}Ax=A^{T}b;
(2) decompose A^{T}A to obtain LDL^{T}x=A^{T}b;
(3) solve LY=A^{T}b to obtain Y; and
(4) solve DL^{T}x=Y to obtain x, that is, obtain the model parameter pᵢ in the prediction model, where a value of i is greater than or equal to 0 and less than or equal to a total number of model parameters.

In both a process of constructing the expression of the cross-component prediction model and performing model calculation when the first component is a luminance component Y and the second component is a first chrominance component U and a process of constructing the expression of the cross-component prediction model and performing model calculation when the first component is a luminance Y and the second component is a second chrominance component V, A^{T}A needs to be decomposed. Therefore, in this embodiment of this application, decomposing processes of A^{T}A in the two model calculation processes can be further combined to reduce calculation complexity.
S303: Input a reconstructed value of the first component of the current coding block to the cross-component prediction model, the cross-component prediction model being configured for performing cross-component prediction on the current coding block based on the mapping relationship indicated by the cross-component prediction model, to obtain a predicted value of the second component of the current coding block; and the predicted value of the second component of the current coding block being configured for reconstructing a reconstructed image of the current coding block.

After obtaining the cross-component prediction model corresponding to the current coding block, the decoding end may calculate the predicted value of the second component of the current coding block only by substituting the reconstructed value of the first component of the current coding block to the cross-component prediction model, to reconstruct the predicted image of the current coding block based on the predicted value of the second component. Further, after obtaining the residual information of the current coding block by parsing the image bitstream sent by the coding end, the decoding end performs an addition operation on the predicted image of the current coding block and the residual information, and an operation result is the reconstructed image of the current coding block obtained by the decoding end.

The cross-component prediction process shown in operations S301 to S303 further needs to be described as follows:
(1) In operations S301 to S303, the intra-frame prediction process of cross-component prediction is described by using the current coding block as an example. However, cross-component prediction models used for to-be-decoded coding blocks of different sizes in the image bitstreams may be different or the same. If prediction modes selected for to-be-coded coding blocks of different sizes are different, cross-component prediction modes constructed for the coding blocks based on the different prediction modes are also different. Similarly, template regions of to-be-coded coding blocks of different sizes in the current image may be the same or different. That is, when template regions are selected for to-be-coded coding blocks of different sizes, the selected template regions may be different or the same, to improve matching between the selected template regions and the coding blocks, thereby ensuring prediction quality of each coding block. For example, when predicting different coding blocks, different template regions may be selected from a plurality of neighboring regions of the coding blocks, to construct cross-component prediction models of the coding blocks to predict the second components, thereby improving prediction accuracy of each coding block. The decoding end may select a template region of each coding block based on a relationship between a horizontal size (for example, a width size) and a vertical size (for example, a height size) of the coding block. For example, when a horizontal size of the current coding block is greater than a vertical size, the region B of the plurality of neighboring regions of the current coding block may be selected as the template region, and when the horizontal size of the current coding block is less than the vertical size, the region D of the plurality of neighboring regions of the current coding block may be selected as the template region.
(2) In this embodiment of this application, the prediction mode, the template region, or the preprocessing manner can be represented as a variant.

In an implementation, when there are a plurality of variants (for example, a plurality of variants are simultaneously applied to the same coding block), the decoding end may obtain a selection indication index by parsing the image stream by using an explicit (for example, directly analyzing a value of a bit in the image bitstream) index or an implicit (as described above, a plurality of parameters are obtained by parsing the image bitstream, and indexing is performed based on a result obtained after operation of the plurality of parameters) index. The selection indication index is used to indicate a target variant that is of the plurality of variants and that is applied to the current coding block. For example, the variant is a prediction mode (for example, the foregoing equation to be used for model calculation). When there are a plurality of prediction modes, the decoding end may obtain a selection indication index by parsing the image bitstream. The selection indication index indicates selecting, from the Q prediction modes for the current coding block, one or more prediction modes for constructing the cross-component prediction model. The selected one or more prediction modes are used as target variants for subsequent calculation. On the decoding end, the manner of selecting a target variant from a plurality of variants by parsing the image bitstream, to perform a subsequent operation can effectively reduce calculation complexity of the decoding end and improve the component prediction speed and efficiency.

In another implementation, when there are a plurality of variants, cross-component prediction may be performed on the current coding block based on the plurality of variants, to obtain a plurality of candidate images corresponding to the current coding block. One candidate image corresponds to one variant. Weighting processing is performed on the plurality of candidate images to obtain a weighted image. The weighted image is used as an image of the current coding block. That is, a plurality of variants may be applied to the same coding block, and a weighting operation is performed on a plurality of results obtained after the plurality of variants are applied to the same coding block, to obtain a result after the weighting operation. The result obtained after the weighting operation is used as a final prediction result of the same coding block. For example, the variant is a prediction mode. For example, the decoding end may select, for the current coding block from the Q prediction modes, at least two prediction modes for constructing the cross-component prediction model, construct expressions of a plurality of cross-component prediction models for the current coding block based on each of the at least two prediction modes, and solve a model parameter of an expression of each cross-component prediction model, to obtain the plurality of cross-component prediction models of the current coding block. In this case, cross-component prediction may be performed on the second component of the current coding block by using each of the plurality of cross-component prediction models with reference to the reconstructed value of the first component of the current coding block, to obtain a prediction result of the second component of the current coding block outputted by each cross-component prediction model. Further, a weighting operation is performed on prediction results of the second component of the current coding block outputted by the plurality of cross-component prediction models, to obtain a weighted prediction result. The weighted prediction result may be used as the final prediction result of the second component of the current coding block.
(3) After determining the current coding block in the image bitstream, the decoding end first determines whether cross-component prediction needs to be performed on the current coding block by using the cross-component prediction model, and only when cross-component prediction needs to be performed on the current coding block, performs the specific implementation process shown in operations S302 and S303. Otherwise, the current coding block may be decoded in a conventional manner such as intra-frame prediction or inter-frame prediction. A condition for determining whether cross-component prediction needs to be performed on the current coding block includes one or more of the following:
(1) Determine, according to a prediction index obtained by parsing the image bitstream, whether cross-component prediction needs to be performed on the current coding block. The prediction index is configured for indicating whether cross-component prediction needs to be performed on the current coding block, and the prediction index is located in one or more of a sequence header, an image header, a slice header, and a largest coding block in the image bitstream. That is, when the coding end performs cross-component prediction on the current coding block, the coding end notifies the decoding end through the prediction index. To ensure consistency of processing of the current coding block by the coding end and the decoding end, the decoding end needs to predict the current coding block through the same cross-component prediction as the coding end. In some embodiments, if the prediction index is set in a sequence header of a current sequence to which the current coding block belongs, the sequence header includes a sequence header identifier, and the sequence header identifier is used to identify whether cross-component prediction needs to be performed. When the sequence header identifier (for example, 1) indicates that cross-component prediction needs to be performed, it indicates that cross-component prediction is performed on all coding blocks (including the current coding block) included in the current sequence. In some embodiments, if the prediction index is set in an image header of a current image to which the current coding block belongs, the image header includes an image header identifier, and the image header identifier is used to indicate whether cross-component prediction needs to be used. When the image header identifier (for example, 1) indicates that cross-component prediction needs to be performed, it indicates that cross-component prediction is performed on all coding blocks (including the current coding block) included in the current image. In some embodiments, if the prediction index is set in a slice header of a current slice to which the current coding block belongs, the slice header includes an image header identifier, and the image header identifier is used to identify whether cross-component prediction needs to be performed. When the image header identifier (for example, 1) indicates that cross-component prediction needs to be performed, it indicates that cross-component prediction is performed on all coding blocks (including the current coding block) included in the current slice. In some embodiments, if the prediction index is set in the current coding block, when the prediction index indicates that cross-component prediction needs to be performed, it is determined that cross-component prediction needs to be performed on the current coding block.
(2) Determine, according to a block characteristic of the current coding block, whether cross-component prediction needs to be performed on the current coding block; where the block characteristic of the current coding block includes: a size of the current coding block and a position of the current coding block in the image. In some embodiments, when a block characteristic of the current coding block is a size of the current coding block, whether cross-component prediction is performed on the current coding block needs to be indicated based on whether the size of the current coding block meets a preset size range limit. If cross-component prediction is performed when the size of the current coding block is excessively large or excessively small, cross-component prediction accuracy may be low. Therefore, to ensure better prediction, in this embodiment of this application, whether cross-component prediction needs to be performed can be determined based on the size of the current coding block. In some embodiments, when a block characteristic of the current coding block is an image of the current coding block in the image, whether cross-component prediction is performed on the current coding block needs to be indicated based on whether a position of the current coding block meets a preset position range limit. For example, if the current coding block is the first to-be-predicted coding block in the current image, there is no neighboring reconstructed pixel for the current coding block, and therefore cross-component prediction cannot be performed.

Specific content of the size range limit and the position range limit is preset according to an actual coding and decoding requirement. This is not limited in this embodiment of this application.
(3) Determine, according to a template characteristic of the template region corresponding to the current coding block, whether cross-component prediction needs to be performed on the current coding block; where the template characteristic of the template region includes: a template area of the template region and/or a quantity of usable sampling points included in the template region. That is, whether cross-component prediction is performed on the current coding block may be indicated according to a template characteristic of the template region of the current coding block. In some embodiments, when a template area of the template region of the current coding block is greater than an area threshold, it indicates that the template region is sufficiently large, and sampling points included in the template region are sufficient to calculate the model parameter. Therefore, cross-component prediction needs to be performed on the current coding block. In some embodiments, when the quantity of usable sampling points in the template region of the current coding block is greater than a quantity of model parameters included in the expression of the cross-component prediction model of the current coding block, it indicates that there are sufficient sampling points for calculating the model parameters of the cross-component prediction model. In this case, cross-component prediction needs to be performed on the current coding block.

In conclusion, the cross-component prediction model in this embodiment of this application is constructed based on similarity between mapping relationships between different components of reconstructed pixels in the image bitstream. The cross-component prediction model for indicating the mapping relationship between the first component and the second component of the current coding block is constructed based on similarity with a mapping relationship between components in the neighboring region of the current coding block. In this way, the cross-component prediction model can be refined. Further, when the first component of the current coding block has been reconstructed and the second component of the current coding block has not been reconstructed, the predicted value of the second component can be predicted across components based on the mapping relationship between the first component and the second component of the current coding block indicated by the refined cross-component prediction model, and the reconstructed value of the first component. This not only ensures higher accuracy of the predicted value of the second component, but also significantly improves prediction quality, thereby improving coding and decoding efficiency.

The above embodiment in FIG. 3 mainly describes the specific implementation process of the image processing method provided in the embodiments of this application on the decoding end. A specific implementation process in which the coding block implements the image processing method is similar to the specific implementation process in which the decoding end implements the image processing method.

The following provides a general implementation process of the image processing method on the coding side with reference to FIG. 12. For specific implementation of some operations, refer to related description of corresponding content on the decoding side. A process of performing cross-component prediction by a coding end may include but is not limited to operations S1201 to S1204.

S1201: Determine a current coding block in an image.

When coding an image (for example, a single image or any video frame in a video), to improve an image compression rate and reduce storage and transmission costs, a coding end needs to divide the image into blocks. Specifically, according to the foregoing related description of the block division structure, the image may be divided into a plurality of non-overlapping coding units (CU). The current coding block in the image is a current to-be-coded coding unit in the image.

S1202: Obtain a cross-component prediction model.

The cross-component prediction model may be generated offline or online.
1. The cross-component prediction model is generated offline. Offline generation means: before a coding end codes the current coding block, a model parameter of the cross-component prediction model has been calculated. In this implementation, the coding end only needs to determine a model parameter for calculating the cross-component prediction model, and directly construct the cross-component prediction model based on the model parameter (specifically, the model parameter is substituted to an expression of the cross-component prediction model, to obtain a cross-component prediction model in which the model parameter is known and only the first component and the second component are unknown). As can be seen, when the cross-component prediction model is generated offline, this can ensure that the generated cross-component prediction model can be quickly invoked when predicting the second component for the current coding block, thereby improving the prediction speed and efficiency of the second component of the current coding block.

A manner of determining the model parameter by the coding end may include: After being generated (for example, generated based on another image) offline, the model parameter of the cross-component prediction model is preset in the coding end (for example, preset in a coding and decoding protocol stored in the coding end). In this way, when needing to predict the second component of the current coding block in the image, the coding end may directly invoke the model parameter, and substitute the model parameter to the cross-component prediction model to obtain the cross-component prediction model in which the model parameter is known and only an independent variable (for example, the first component) and a dependent variable (for example, the second component) are unknown. Therefore, the predicted value of the second component of the current coding block can be obtained only by substituting the reconstructed value of the reconstructed first component of the current coding block in the image to the cross-component prediction model.
2. The cross-component prediction model is generated online. Online generation means: in a process of coding the to-be-coded current coding block in the current image, the coding end calculates and constructs each model parameter in the expression of the cross-component prediction model of the current coding block online, to obtain the calculated cross-component prediction model online. Generating the cross-component prediction model of the current coding block online has the following advantage: the generated cross-component prediction model highly matches with the current coding block (this is reflected in that a mapping relationship between the first component and the second component of the current coding block is more similar to a mapping relationship between the first component and the second component of reconstructed pixels that are in a neighboring region of the current coding block and that are configured for constructing the cross-component prediction model). Therefore, prediction accuracy of the second component is ensured when the second component of the current coding block is predicted by using the highly matching cross-component prediction model, thereby improving quality of the predicted image of the current coding block.

A specific implementation process of generating the cross-component prediction model corresponding to the current coding block online may include but is not limited to the following operations s21 to s24:
s21: Construct an expression of the cross-component prediction model of the current coding block based on sampling points of reconstructed pixels in the image bitstream in a first component dimension and sampling points of the reconstructed pixels in a second component dimension.

In specific implementation, the coding end constructs a plurality of cross-component matching pairs of reconstructed pixels in the image bitstream in a neighboring region of the current coding block. One cross-component matching pair includes one first component and one second component, the first component includes one or more sampling points, the second component includes one sampling point, and a position of a sampling point of the one or more sampling points included in the first component and a position of the sampling point included in the second component are associated positions or the same position.

Further, before the plurality of cross-component matching pairs are constructed, in this embodiment of this application, reconstructed pixels of the first component and/or reconstructed pixels of the second component can be further preprocessed. A preprocessing manner of the preprocessing includes any one of the following:
(1) Extend boundary of a template region in the first component dimension according to a characteristic of the cross-component prediction model.
(2) Resample the first component of the current coding block when resolutions of the first component and the second component of the current coding block are different.
(3) Trigger to perform the operation of constructing a plurality of cross-component matching pairs of reconstructed pixels in the image bitstream when the resolutions of the first component and the second component of the current coding block are different.
(4) Filter the first component of the current coding block by using one or more filters.

The coding end further needs to determine a target prediction mode. The target prediction mode may be understood as an expression of an equation. The equation merely represents a mapping relationship between a sampling point in the first component dimension and a sampling point in the second component dimension, and does not include specific values of components. The target prediction mode is obtained based on one or more of the Q prediction modes. When the target prediction mode is obtained by using one of the Q prediction modes, the one prediction mode is directly used as the target prediction mode. When the target prediction mode is obtained by using at least two of the Q prediction modes, the target prediction mode may be obtained by performing weighting processing on the at least two prediction modes.

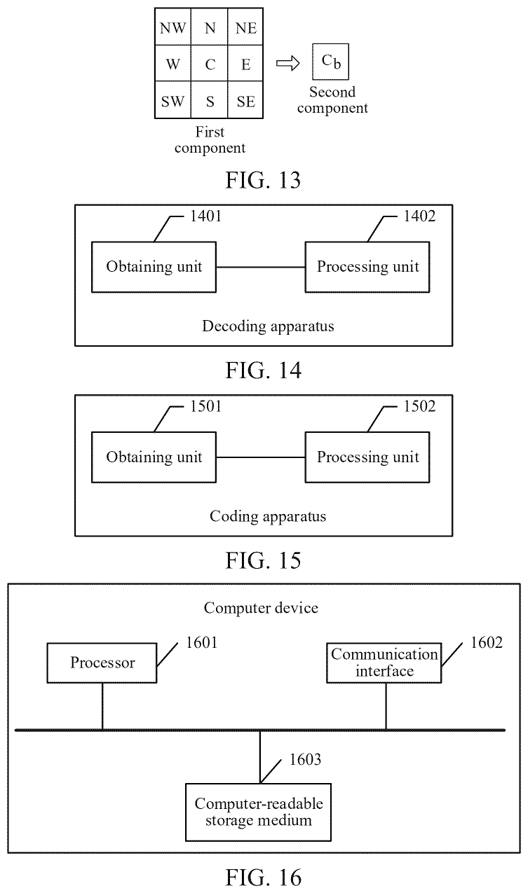

The prediction mode may be represented as an expression, and the expression is an equation. The constructing the prediction mode provided in this embodiment of this application may include: constructing the prediction mode based on the mapping relationship between the first component and the second component, the sampling points of the reconstructed pixels in the current image in the first component dimension, and the sampling points of the reconstructed pixels in the image bitstream in the second component dimension. An order of the constructed prediction mode is the first order or a higher order. For example, the cross-component matching pair shown in FIG. 13 includes sampling points in the first component dimension and sampling points in the second component dimension, and the prediction mode may include, but is not limited to:

$${C}_{b} = {p}_{0} C + {p}_{1} N + {p}_{2} S + {p}_{3} W + {p}_{4} E + {p}_{5} {C}^{2} + {p}_{6} B \qquad a )$$

$${C}_{b} = {p}_{0} C + {p}_{1} N + {p}_{2} S + {p}_{3} W + {p}_{4} E + {p}_{5} B \qquad b )$$

$${C}_{b} = {p}_{0} C + {p}_{1} B \qquad c )$$

$${C}_{b} = {p}_{0} C + {p}_{1} ( \frac{N + S}{2} ) + {p}_{2} ( \frac{W + E}{2} ) + {{p}_{3} ( \frac{N + S}{2} )}^{2} + {{p}_{4} ( \frac{W + E}{2} )}^{2} + {p}_{5} {C}^{2} + {p}_{6} B \qquad d )$$

$${C}_{b} = {p}_{0} C + {p}_{1} ( \frac{N + S}{2} ) + {p}_{2} ( \frac{W + E}{2} ) + {{p}_{3} ( \frac{N + S}{2} )}^{2} + {{p}_{4} ( \frac{W + E}{2} )}^{2} + {p}_{5} ( \frac{N + S}{2} ) ( \frac{W + E}{2} ) + {p}_{6} B \qquad e )$$

$${C}_{b} = {p}_{0} C + {p}_{1} ( \frac{N + S}{2} ) + {p}_{2} ( \frac{W + E}{2} ) + {p}_{3} ( \frac{N W + S E}{2} ) + {p}_{4} ( \frac{N E + S W}{2} ) + {p}_{5} {C}^{2} + {p}_{6} B \qquad f )$$

$${C}_{b} = {p}_{0} C + {p}_{1} ( \frac{N + S}{2} ) + {p}_{2} ( \frac{W + E}{2} ) + {p}_{3} ( \frac{N W + S E}{2} ) + {p}_{4} ( \frac{N E + S W}{2} ) + {p}_{5} ( \frac{N + S}{2} ) ( \frac{W + E}{2} ) + {p}_{6} B \qquad g )$$

$${C}_{b} = {p}_{0} C + {p}_{1} ( \frac{N + S}{2} ) + {p}_{2} ( \frac{W + E}{2} ) + {p}_{3} ( \frac{N W + S E}{2} ) + {p}_{4} ( \frac{N E + S W}{2} ) + {p}_{5} B \qquad h )$$

$${C}_{b} = {p}_{0} ( \frac{N + S + W + E}{4} ) + {p}_{1} ( \frac{N + W}{2} ) + {p}_{2} ( \frac{N + E}{2} ) + {p}_{3} ( \frac{S + W}{2} ) + {p}_{4} ( \frac{S + E}{2} ) + {{p}_{5} ( \frac{N + S + W + E}{4} )}^{2} + {p}_{6} B \qquad i )$$

$${C}_{b} = {p}_{0} ( \frac{N + S + 4 C + W + E}{8} ) + {p}_{1} ( \frac{N + W}{2} ) + {p}_{2} ( \frac{N + E}{2} ) + {p}_{3} ( \frac{S + W}{2} ) + {p}_{4} ( \frac{S + E}{2} ) + {{p}_{5} ( \frac{N + S + 4 C + W + E}{8} )}^{2} + {p}_{6} B \qquad j )$$

$${C}_{b} = {p}_{0} C + {p}_{1} ( \frac{N + W}{2} ) + {p}_{2} ( \frac{N + E}{2} ) + {p}_{3} ( \frac{S + W}{2} ) + {p}_{4} ( \frac{S + E}{2} ) + {p}_{5} {C}^{2} + {p}_{6} B \qquad k )$$

The sampling point N, the sampling point S, the sampling point C, the sampling point E, and the sampling point W in the prediction mode are sampling points included in the first component in the cross-component matching pair shown in FIG. 6. The sampling point C_{b} is a sampling point in the second component in the cross-component matching pair, and a position of the sampling point C and a position of the sampling point C_{b} are associated positions (for example, the positions are close to each other) or the same position. B is a constant bias term, and p₀, p₁, p₂, p₃, p₄, p₅, and p₆ are model parameters.

In addition, as can be known from the exemplary prediction mode, the constructed prediction mode includes at least one monomial and a coefficient of each of the at least one monomial. (1) The monomial includes at least one of the following: a constant term and a sampling point term that is constructed by at least one sampling point in the first component, a manner of constructing the sampling point term includes one or more of the following: a single sampling point, an m1^{th}-order of a single sampling point, a multiple of a single sampling point, an operation formula formed by at least two sampling points, an m1^{th}-order of an operation formula formed by at least two sampling points, and an operation formula formed by an m3^{th}-order of some sampling points of at least two sampling points and a remaining sampling point of the at least two sampling points, where m1, m2, and m3 are the same or different and m1, m2, and m3 are non-zero real numbers. For example, the monomial may include but is not limited to at least one of the following: x, y, mx±ny, xy, x^{k}, (mx±ny)^{k}, (mx±ny) (pz±qf), (mx±ny) x, and the constant bias term B. The monomial may alternatively be a multiplication combination of the monomial examples. For example, the monomial may be x (mx±ny) and y (mx±ny) and the like. A form of the monomial is not limited in this embodiment of this application. In the monomial, m, n, p, and q are non-zero integers, x and y are fixed weights, and k is an order and is a non-zero real number. (2) The coefficient of each of the at least one monomial, as a parameter for model calculation, is obtained by parsing the image bitstream or calculated based on the model.

Further, after determining the target prediction mode, the coding end generates a prediction sub-equation for each of the constructed plurality of cross-component matching pairs according to the target prediction mode. That is, a quantity of the constructed cross-component matching pairs is the same as a quantity of prediction sub-equations included in the expression of the cross-component prediction model.
s22: Determine a template region in the second component dimension for the current coding block.

During specific implementation, the coding end may first determine a plurality of neighboring regions of the current coding block in the second component dimension. For example, the plurality of neighboring regions may be a region A, a region B, a region C, a region D, and a region E shown in FIG. 13. Then, the coding end selects the template region of the current coding block from the plurality of neighboring regions of the current coding block in the second component dimension.

Not all the plurality of neighboring regions of the current coding block may be usable, that is, not all sampling points in the plurality of neighboring regions may be used for model calculation. Specifically, it is assumed that any of the plurality of neighboring regions of the current coding block represents a target region. When a second component in a target sub-region within the target region is not reconstructed or the target sub-region within the target region extends beyond boundary of the image, it is determined that the target region is unusable. Specifically, all or some sampling points within the target region cannot be used for model parameter calculation. According to different target regions, target sub-regions within the target region may be different. For example, when the target region is the region C or the region E, the target sub-region within the target region may be a sub-region at a lower right corner of the target region. Further, the target region being unusable may specifically include any one of the following:
1) All sampling points included in the target region are unusable.
2) An unusable sampling point included in the target region is unusable.

Further, based on the related descriptions of the plurality of neighboring regions of the current coding block, a manner of selecting the template region of the current coding block from the plurality of neighboring regions of the current coding block includes at least one of the following:
1) Use all the plurality of neighboring regions of the current coding block as the template region of the current coding block.
2) Use some of the plurality of neighboring regions of the current coding block as the template region of the current coding block.
s23: Select target sampling points for model calculation from the template region in the second component dimension.

After the template region is determined for the current coding block based on operation s22, the target sampling points for calculating the model parameter in the expression of the cross-component prediction model of the current coding block may be determined in the template region. A manner of selecting the target sampling points for model calculation from the template region in the second component dimension includes any one of the following:
1) All sampling points are used, that is, all sampling points in the template region of the current coding block are used as the target sampling points for model calculation.
2) Some sampling points are used, that is, some sampling points are selected from the template region of the current coding block as the target sampling points for model calculation. A manner of selecting some sampling points from the template region of the current coding block includes any one of the following:
(1) Select sampling points according to coordinate positions of sampling points in the template region of the current coding block. Specifically, sampling points whose first coordinate positions and/or second coordinate positions satisfy a constraint condition are selected from the template region of the current coding block. A direction of the first coordinate position is a horizontal direction of the template region of the current coding block, and a direction of the second coordinate position is a vertical direction of the template region of the current coding block. That the first coordinate positions and/or the second coordinate positions satisfy the constraint condition includes any one of the following: the first coordinate positions and/or the second coordinate positions are even number positions, odd number positions, or all positions in a corresponding direction.
(2) Scan the template region of the current coding block to determine sampling points of specified coordinate positions for model calculation. Specifically, the target sampling points are selected from the template region of the current coding block in a target scanning manner. The target scanning manner includes but is not limited to: a sawtooth scanning manner (a scanning manner such as zigzag), a round-trip scanning manner, or the like. In a scanning process, a manner of selecting the target sampling points includes at least one of the following:

First manner: selecting sampling points at intervals. For example, each time M points are scanned in a scanning process, one or more scanned points are selected as target sampling points for model calculation, where M is an integer greater than or equal to 1.

Second manner: selecting N sampling points from the template region according to a scanning sequence, where N is an integer greater than 1, the N sampling points are continuously scanned in the template region, and the N sampling points are located in a front scanning region, a middle scanning region, or a rear scanning region of the template region according to the scanning sequence. That is, in a process of scanning the template region of the current coding block, the coding end may select N sampling points that are first scanned (the N sampling points are located in the front scanning region of the template region), or N sampling points that are scanned in the middle of scanning (the N sampling points are located in the middle scanning region of the template region), or N sampling points that are last scanned (the N sampling points are located in the rear scanning region of the template region) as the target sampling points for model calculation.
(3) Determine whether sampling point values of sampling points in the template region of the current coding block satisfy a specified condition, to determine target sampling points for model calculation selected for the current coding block. Specifically, the coding end may select sampling points whose sampling point values satisfy a specified condition from the template region of the current coding block; where that the sampling point values of the sampling points satisfy the specified condition at least includes: values of first components of the sampling points are greater than a value threshold or the values of the first components of the sampling points are less than or equal to a value threshold.

In this embodiment of this application, a plurality of sampling points whose first components have values greater than the value threshold can also be selected from the template region of the current coding block, and the model parameter in the expression of the cross-component prediction model can be calculated by using the plurality of sampling points, to obtain a cross-component prediction model. In addition, a plurality of sampling points whose first components have values less than or equal to the value threshold can be selected from the template region of the current coding block, and the model parameter in the expression of the cross-component prediction model can be calculated by using the plurality of sampling points, to obtain a cross-component prediction model. In this way, when generating the predicted value of the second component for the current coding block, whether a luminance value of a luminance component of the current coding block is greater than the value threshold may be determined first. If a luminance value of a luminance component of the current coding block is greater than the value threshold, the second component of the current coding block is predicted by using the cross-component prediction model trained in a training stage by using sampling points whose luminance values are greater than the luminance threshold. Otherwise, if a luminance value of a luminance component of the current coding block is less than or equal to the value threshold, the second component of the current coding block is predicted by using the cross-component prediction model trained in a training stage by using sampling points whose luminance values are less than or equal to the luminance threshold. As can be seen, a plurality of cross-component prediction models are trained in different cases, and the second component is predicted during model application by using a matching cross-component prediction model. In this way, prediction accuracy of the second component can be improved to some extent.
(4) Select sampling points from a specified position or region of the template region of the current coding block as target sampling points for model calculation. Specifically, the coding end may select sampling points from a default position of the template region of the current coding block as target sampling points for model calculation. The default position may be referred to as a specified position, and may include at least one of the following: a middle position (or another specified position or region) of the template region of the current coding block, or a neighboring position close to the current coding block in the template region of the current coding block, or the like.
s24: Calculate a model parameter in the expression of the cross-component prediction model based on the target sampling points in a calculation manner of solving a linear equation, to obtain the cross-component prediction model.

Based on the foregoing operations, the expression of the cross-component prediction model of the current coding block is constructed, and a plurality of target sampling points are selected for calculation of the expression of the cross-component prediction model. Therefore, the model parameter of the expression of the cross-component prediction model may be linearly solved by using the plurality of target sampling points selected from the template region of the current coding block, to obtain a specific value of each model parameter in the expression of the cross-component prediction model. Therefore, the cross-component prediction model is obtained after model calculation. The model parameter in the cross-component prediction model is known after model calculation, an independent variable is the first component, and a dependent variable is the second component.

Further, a model parameter in the expression Ax=b of the cross-component prediction model may be solved by solving a linear equation, to obtain the model parameter. Therefore, the cross-component prediction model is constructed. A method for solving the expression Ax=b is not limited in this embodiment of this application, and may include, but is not limited to, an LDL decomposition method, a Gaussian elimination method, or the like. Exemplarily, a process of solving the expression Ax=b by using the LDL decomposition method may roughly include:
(1) multiply both sides of the equation by transpose of a matrix A, to obtain A^{T}Ax=A^{T}b;
(2) decompose A^{T}A to obtain LDL^{T}x=A^{T}b;
(3) solve LY=A^{T}b to obtain Y; and
(4) solve DL^{T}x=Y to obtain x, that is, obtain the model parameter pᵢ in the prediction model, where a value of i is greater than or equal to 0 and less than or equal to a total number of model parameters.
S1203: Input a reconstructed value of the first component of the current coding block to the cross-component prediction model, the cross-component prediction model being configured for performing cross-component prediction on the current coding block based on the mapping relationship indicated by the cross-component prediction model, to obtain a predicted value of the second component of the current coding block.
S1204: Code the current coding block based on the predicted value of the second component of the current coding block, to generate an image bitstream.

In operations S1203 and S1204, after constructing the cross-component prediction model, the coding end may calculate the predicted value of the second component of the current coding block by substituting the reconstructed value of the first component of the current coding block to the cross-component prediction model, to reconstruct the predicted image of the current coding block based on the predicted value of the second component. Further, the coding end may obtain residual information of the current coding block by performing a difference operation on the real image and the predicted image of the current coding block. In this way, the coding end may code the residual information of the current coding block to generate the image bitstream and send the image bitstream to the decoding end for decoding.

When compressing and coding the residual information of the current coding block, the coding end compresses, into the image bitstream, index information (for example, index information indicating template region selection, and for another example, index information indicating prediction mode selection) that needs to be transmitted to the decoding end. In this way, the decoding end can obtain the corresponding index information based on the image bitstream when decoding a coding block in the image bitstream, and calculate each model parameter in the expression of the cross-component prediction model based on the index information by using a model calculation procedure that is the same as that of the coding end, to reconstruct the image compressed by the coding end.
(1) When coding the current image, the coding end may use different cross-component prediction models or the same model for to-be-coded coding blocks of different sizes in the current image. If prediction modes selected for to-be-coded coding blocks of different sizes are different, cross-component prediction modes constructed for the coding blocks based on the different prediction modes are also different. Similarly, template regions of to-be-coded coding blocks of different sizes in the current image may be the same or different. That is, when template regions are selected for to-be-coded coding blocks of different sizes, the selected template regions may be different or the same, to improve matching between the selected template regions and the coding blocks, thereby ensuring prediction quality of each coding block. For example, when predicting different coding blocks, different template regions may be selected from a plurality of neighboring regions of the coding blocks, to construct cross-component prediction models of the coding blocks to predict the second components, thereby improving prediction accuracy of each coding block. The coding end selects a template region of each coding block based on a relationship between a horizontal size (for example, a width size) and a vertical size (for example, a height size) of the coding block. For example, when a horizontal size of the current coding block is greater than a vertical size, the region B of the plurality of neighboring regions of the current coding block is selected as the template region, and when the horizontal size of the current coding block is less than the vertical size, the region D of the plurality of neighboring regions of the current coding block is selected as the template region.
(2) In this embodiment of this application, the prediction mode, the template region, or the preprocessing manner can be represented as a variant.

In an implementation, when there are a plurality of variants (for example, a plurality of variants are simultaneously configured for the same coding block), when coding the current coding block, the coding end may compress, into the image bitstream, an index indicating a target variant of the plurality of variants. In this way, the decoding end can select the target variant from the plurality of variants based on the index, to perform a subsequent operation. For example, if the variant is a prediction mode and there are a plurality of prediction modes, the coding end may construct a plurality of cross-component prediction models based on different prediction modes of the plurality of prediction modes. Then, the coding end may determine a better cross-component prediction model from the plurality of cross-component prediction models according to a requirement (for example, a requirement such as better prediction performance or lower calculation complexity), and add an indication index during compression and coding, to instruct the decoding end to select the better cross-component prediction model determined by the coding end, to perform decoding. In the foregoing process, a better cross-component prediction model can be calculated on the coding end, and calculation complexity can be reduced and decoding efficiency can be improved on the decoding end.

In another implementation, when there are a plurality of variants, cross-component prediction may be performed on the current coding block based on the plurality of variants, to obtain a plurality of candidate images corresponding to the current coding block. One candidate image corresponds to one variant. Weighting processing is performed on the plurality of candidate images to obtain a weighted image. The weighted image is used as an image of the current coding block. That is, a result of a weighting operation performed on a plurality of results obtained after the plurality of variants are applied to the same coding block may be used as a final prediction result of the same coding block. Certainly, the coding end needs to notify the decoding end of a manner of performing a weighting operation in a case of a plurality of variants, so that the decoding end performs decoding in the manner that is the same as that of the coding end.
(3) After determining the current coding block in the image bitstream, the coding end first determines whether cross-component prediction needs to be performed on the current coding block by using the cross-component prediction model, and only when cross-component prediction needs to be performed on the current coding block, performs the specific implementation process shown in operations S1202 and S1203. Otherwise, the current coding block may be coded in a conventional manner such as intra-frame prediction or inter-frame prediction. A condition for determining whether cross-component prediction needs to be performed on the current coding block includes one or more of the following:
(1) Determine, according to a block characteristic of the current coding block, whether cross-component prediction needs to be performed on the current coding block; where the block characteristic of the current coding block includes: a size of the current coding block and a position of the current coding block in the image.
(2) Determine, according to a template characteristic of the template region corresponding to the current coding block, whether cross-component prediction needs to be performed on the current coding block; where the template characteristic of the template region includes: a template area of the template region and/or a quantity of usable sampling points included in the template region.

In conclusion, in this embodiment of this application, in the process of coding the image by the coding end, the predicted value of the second component of the current coding block can be predicted based on the first component of reconstructed pixels, thereby implementing cross-component prediction and improving prediction efficiency. In addition, cross-component prediction is specifically implemented by using the more refined cross-component prediction model, and the cross-component prediction model is constructed based on similarity between mapping relationships between different components of reconstructed pixels. Therefore, higher-quality predicted pixels of the current coding block can be generated based on the refined cross-component prediction model, thereby significantly improving prediction quality and coding efficiency.

The above provides detailed description of the method of the embodiments of this application. In order to facilitate the better implementation of the above solution of the embodiments of this application, an apparatus of the embodiments of this application is correspondingly provided below.

FIG. 14 is a schematic structural diagram of a decoding apparatus according to an embodiment of this application. The decoding apparatus may be disposed in a computer device provided in the embodiments of this application. The computer device may be the terminal or the server mentioned in the foregoing method embodiments. In some embodiments, the decoding apparatus may be a computer program (including program code) running in a computer device. The decoding apparatus may be configured to perform corresponding operations in the method embodiment shown in FIG. 3. With reference to FIG. 14, the decoding apparatus may include the following units:
an obtaining unit 1401, configured to determine a current coding block in an image bitstream, the current coding block including a first component and a second component, and the first component of the current coding block having been reconstructed; and
a processing unit 1402, configured to obtain a cross-component prediction model, the cross-component prediction model being configured for indicating a mapping relationship between the first component of the current coding block and the second component of the current coding block; and
the processing unit 1402 being further configured to input a reconstructed value of the first component of the current coding block to the cross-component prediction model, the cross-component prediction model being configured for performing cross-component prediction on the current coding block based on the mapping relationship indicated by the cross-component prediction model, to obtain a predicted value of the second component of the current coding block, and the predicted value of the second component of the current coding block being configured for reconstructing a reconstructed image of the current coding block.

In an implementation, the first component and the second component include any one of the following:
the first component is a luminance component Y, and the second component is a first chrominance component U; or
the first component is a luminance component Y, and the second component is a second chrominance component V; or
the first component is a first chrominance component U, and the second component is a second chrominance component V; or
the first component is a luminance component and a first chrominance component YU, and the second component is a second chrominance component V; or
the first component is a luminance component and a second chrominance component YV, and the second component is a first chrominance component U.

In an implementation, the cross-component prediction model is generated online; and when obtaining the cross-component prediction model, the processing unit 1402 is specifically configured to:
construct an expression of the cross-component prediction model of the current coding block based on sampling points of reconstructed pixels in the image bitstream in a first component dimension and sampling points of the reconstructed pixels in a second component dimension;
determine a template region in the second component dimension for the current coding block;
select target sampling points for model calculation from the template region; and
calculate a model parameter in the expression of the cross-component prediction model based on the target sampling points in a calculation manner of solving a linear equation, to obtain the cross-component prediction model.

In an implementation, the expression of the cross-component prediction model includes a plurality of prediction sub-equations; and when constructing the expression of the cross-component prediction model of the current coding block based on the sampling points of the reconstructed pixels in the image bitstream in the first component dimension and the sampling points of the reconstructed pixels in the second component dimension, the processing unit 1402 is specifically configured to:
construct a plurality of cross-component matching pairs of the reconstructed pixels in the image bitstream; where one cross-component matching pair includes one first component and one second component, the first component includes one or more sampling points, the second component includes one sampling point, and a position of a sampling point of the one or more sampling points included in the first component and a position of the sampling point included in the second component are associated positions or the same position;
determine a target prediction manner, and generate a target prediction mode according to the target prediction manner, where the target prediction manner is used to indicate: selecting one prediction mode from Q prediction modes as the target prediction mode, or selecting at least two prediction modes from the Q prediction modes for weighting processing to obtain the target prediction mode, Q is an integer greater than or equal to 1, and the target prediction mode is used to represent prediction logic for predicting the second component based on the first component; and
generate a prediction sub-equation for each cross-component matching pair of the plurality of cross-component matching pairs according to the target prediction mode.

In an implementation, the processing unit 1402 is further configured to:
obtain reconstructed pixels of the first component, and preprocess the reconstructed pixels of the first component, to obtain sampling points of the reconstructed pixels of the first component in the first component dimension; and/or
obtain reconstructed pixels of the second component, and preprocess the reconstructed pixels of the second component, to obtain sampling points of the reconstructed pixels of the second component in the second component dimension; where following:
a preprocessing manner of the preprocessing includes at least one of the resampling the first component when resolutions of the first component and the second component are different;
triggering to perform the operation of constructing a plurality of cross-component matching pairs of reconstructed pixels in the image bitstream when the resolutions of the first component and the second component are different; and
filtering the first component by using one or more filters.

In an implementation, the cross-component prediction model is constructed based on the target prediction mode, the target prediction mode is one of Q prediction modes, or the target prediction mode is obtained through weighting processing of at least two of the Q prediction models, Q is an integer greater than or equal to 1, and a manner of constructing the prediction mode includes:
constructing the prediction mode based on the mapping relationship between the first component and the second component, the sampling points of the reconstructed pixels in the image bitstream in the first component dimension, and the sampling points of the reconstructed pixels in the image bitstream in the second component dimension; where
the prediction mode includes at least one monomial and a model parameter of each of the at least one monomial, the monomial includes at least one of the following: a constant term and a sampling point term that is constructed by at least one sampling point in the first component, a manner of constructing the sampling point term includes one or more of the following: a single sampling point, an m1^{th}-order of a single sampling point, a multiple of a single sampling point, an operation formula formed by at least two sampling points, an m1^{th}-order of an operation formula formed by at least two sampling points, and an operation formula formed by an m3^{th}-order of some sampling points of at least two sampling points and a remaining sampling point of the at least two sampling points, m1, m2, and m3 are the same or different and m1, m2, and m3 are non-zero real numbers, and the model parameter of each of the at least one monomial is obtained by parsing the image bitstream or calculated based on the model.

In an implementation, the operation formula formed by at least two sampling points includes: linear weighting of the at least two sampling points, or square of linear weighting of the at least two sampling points; where
one of the Q prediction modes includes:

$${C}_{b} = {P}_{0} ( \frac{N + S + 4 C + W + E}{8} ) + {p}_{1} ( \frac{N + W}{2} ) + {p}_{2} ( \frac{N + E}{2} ) + {p}_{3} ( \frac{S + W}{2} ) + {p}_{4} ( \frac{S + E}{2} ) + {{p}_{5} ( \frac{N + S + 4 C + W + E}{8} )}^{2} + {p}_{6} B$$

A sampling point N, a sampling point S, a sampling point C, a sampling point E, and a sampling point W are sampling points included in the first component, a sampling point C_{b} is a sampling point in the second component, a position of the sampling point C and a position of the sampling point C_{b} are associated positions or the same position, B is a constant bias term, and p₀, p₁, p₂, p₃, p₄, p₅, and p₆ are model parameters.

In an implementation, when determining the template region in the second component dimension for the current coding block, the processing unit 1402 is specifically configured to:
determine a plurality of neighboring regions of the current coding block in the second component dimension; and
select the template region from the plurality of neighboring regions for the current coding block.

In an implementation, the plurality of neighboring regions include at least one of the following: a region A located on the upper left of the current coding block, a region B located right above the current coding block, a region C located on the upper right of the current coding block, a region D located on the left of the current coding block, and a region E located on the lower left of the current coding block.

In an implementation,
a horizontal size of the region C is the same as a horizontal size of the current coding block, a vertical size of the region E is the same as a vertical size of the current coding block, a horizontal size and a vertical size of the region A are the same, vertical sizes of the region A, the region B, and the region C are the same, and horizontal sizes of the region A, the region D, and the region E are the same; where
any one of the plurality of neighboring regions is represented as a target region, and the target region is unusable when a second component in a target sub-region within the target region is not reconstructed, or a target sub-region within the target region extends beyond the boundary of the image; and
the target region being unusable includes any one of the following:
all sampling points included in the target region are unusable; or
an unusable sampling point included in the target region is unusable.

In an implementation, a manner of selecting the template region from the plurality of neighboring regions of the current coding block in the second component dimension for the current coding block includes at least one of the following:
using all the plurality of neighboring regions of the current coding block in the second component dimension as the template region of the current coding block;
using some of the plurality of neighboring regions of the current coding block in the second component dimension as the template region of the current coding block; and
obtaining region indication information by parsing the image bitstream, where the region indication information is used to indicate the template region corresponding to the current coding block; and selecting, as indicated by the region indication information, the template region from the plurality of neighboring regions of the current coding block in the second component dimension for the current coding block.

In an implementation, a manner of selecting the sampling points for model calculation from the template region in the second component dimension includes any one of the following:
using all sampling points in the template region of the current coding block as the target sampling points for model calculation; or
selecting some sampling points from the template region of the current coding block as the target sampling points for model calculation; where
a manner of selecting some sampling points from the template region of the current coding block includes any one of the following:
selecting sampling points whose first coordinate positions and/or second coordinate positions satisfy a constraint condition from the template region of the current coding block; where a direction of the first coordinate position is a horizontal direction, a direction of the second coordinate position is a vertical direction, and that the first coordinate positions and/or the second coordinate positions satisfy the constraint condition includes at least one of the following: the first coordinate positions and/or the second coordinate positions are even number positions, odd number positions, or all positions in a corresponding direction; or
selecting sampling points from the template region of the current coding block in a target scanning manner, where the target scanning manner includes: a sawtooth scanning manner or a round-trip scanning manner, a manner of selecting the target sampling points includes at least one of the following: selecting sampling points at intervals; and selecting N sampling points from the template region according to a scanning sequence, where N is an integer greater than 1, the N sampling points are continuously scanned in the template region, and the N sampling points are located in a front scanning region, a middle scanning region, or a rear scanning region of the template region according to the scanning sequence; or
selecting sampling points whose sampling point values satisfy a specified condition from the template region of the current coding block; where that the sampling point values of the sampling points satisfy the specified condition at least includes: values of first components of the sampling points are greater than a value threshold or the values of the first components of the sampling points are less than or equal to a value threshold; or
selecting sampling points from a default position of the template region of the current coding block, where the default position includes at least one of the following: a middle position of the template region of the current coding block or a neighboring position close to the current coding block in the template region of the current coding block.

In an implementation, the processing unit 1402 is further configured to:
determine whether cross-component prediction needs to be performed on the current coding block by using the cross-component prediction model; where
a condition for determining whether cross-component prediction needs to be performed on the current coding block includes one or more of the following:
determining, according to a prediction index obtained by parsing the image bitstream, whether cross-component prediction needs to be performed on the current coding block; where the prediction index is located in one or more of a sequence header, an image header, a slice header, and a largest coding block in the image bitstream;
determining, according to a block characteristic of the current coding block, whether cross-component prediction needs to be performed on the current coding block; where the block characteristic of the current coding block includes: a size of the current coding block and a position of the current coding block in the image;
determining, according to a template characteristic of the template region corresponding to the current coding block, whether cross-component prediction needs to be performed on the current coding block; where the template characteristic of the template region includes: a template area of the template region and/or a quantity of usable sampling points included in the template region, cross-component prediction is performed on the current coding block when the template area is greater than an area threshold; and cross-component prediction is performed on the current coding block when the quantity of usable sampling points in the template region is greater than a quantity of model parameters included in the expression of the cross-component prediction model of the current coding block.

In an implementation, the prediction mode, the template region, or the preprocessing manner is represented as a variant; and when there are a plurality of variants, the processing unit 1402 is further configured to:
obtain a selection indication index by parsing the image bitstream; where the selection indication index is used to indicate a target variant of the plurality of variants that is applied to the current coding block; and
select a target variant from the plurality of variants for usage according to the selection indication index.

In an implementation, the prediction mode, the template region, or the preprocessing manner is represented as a variant; and when there are a plurality of variants, the processing unit 1402 is further configured to:
perform cross-component prediction on the current coding block based on the plurality of variants, to obtain a plurality of candidate images corresponding to the current coding block; where one candidate image corresponds to one variant;
perform weighting processing on the plurality of candidate images to obtain a weighted image; and
use the weighted image as an image of the current coding block.

In an implementation, the cross-component prediction model is generated offline; and when obtaining the cross-component prediction model, the processing unit 1402 is specifically configured to:
determine a model parameter for calculating the cross-component prediction model; where the model parameter is preset or obtained by parsing the image bitstream; and
obtain a calculated cross-component prediction model based on the model parameter.

According to an embodiment of this application, units of the decoding apparatus shown in FIG. 14 may be separately or wholly combined into one or a plurality of other units, or one (or more) of the units here may further be divided into the plurality of units of smaller functions. In this way, the same operations can be implemented, and implementation of the technical effects of the embodiments of this application is not affected. The foregoing units are divided based on logical functions. In an actual application, a function of one unit may be implemented by a plurality of units, or functions of a plurality of units are implemented by one unit. In another embodiment of this application, the decoding apparatus may further include another unit. In actual application, these functions may alternatively be cooperatively implemented by another unit and may be cooperatively implemented by a plurality of units. According to another embodiment of this application, a computer program (including program code) that can perform the operations related to the corresponding method shown in FIG. 3 may run on a general computing device such as a computer including processing elements and memory elements such as a central processing unit (CPU), a random access memory (RAM), and a read-only memory (ROM), to construct the decoding apparatus shown in FIG. 14 and implement the image processing method in the embodiments of this application. The computer program may be recorded in, for example, a computer-readable recording medium, and may be loaded into the computing device by using the computer-readable recording medium, and run in the computing device.

In this embodiment of this application, in the process of decoding the image bitstream by the decoding end, the predicted value of the second component of the current coding block can be predicted based on the first component of reconstructed pixels, thereby implementing cross-component prediction and improving prediction efficiency. In addition, a new cross-component prediction model may be specifically constructed based on similarity between mapping relationships between different components of reconstructed pixels, and the predicted value of the second component of the to-be-decoded current coding block is predicted based on the cross-component prediction model and a reconstructed component (for example, the first component) of the current coding block. In this way, higher-quality predicted pixels of the current coding block can be generated based on the refined cross-component prediction model, thereby significantly improving prediction quality and coding efficiency.

FIG. 15 is a schematic structural diagram of a coding apparatus according to an embodiment of this application. The coding apparatus may be disposed in a computer device provided in the embodiments of this application. The computer device may be the terminal or the server mentioned in the foregoing method embodiments. In some embodiments, the coding apparatus may be a computer program (including program code) running in a computer device. The coding apparatus may be configured to perform corresponding operations in the method embodiment shown in FIG. 12. With reference to FIG. 15, the coding apparatus may include the following units:
an obtaining unit 1501, configured to determine a current coding block in an image, the current coding block including a first component and a second component, and the first component having been reconstructed; and
a processing unit 1502, configured to obtain a cross-component prediction model, the cross-component prediction model being configured for indicating a mapping relationship between the first component and the second component of the current coding block;
the processing unit 1502 being further configured to input a reconstructed value of the first component of the current coding block to the cross-component prediction model, the cross-component prediction model being configured for performing cross-component prediction on the current coding block based on the mapping relationship indicated by the cross-component prediction model, to obtain a predicted value of the second component of the current coding block, and
the processing unit 1502 being further configured to code the current coding block based on the predicted value of the second component of the current coding block, to generate an image bitstream.

According to an embodiment of this application, units of the coding apparatus shown in FIG. 15 may be separately or wholly combined into one or a plurality of other units, or one (or more) of the units here may further be divided into the plurality of units of smaller functions. In this way, the same operations can be implemented, and implementation of the technical effects of embodiments of this application is not affected. The foregoing units are divided based on logical functions. In an actual application, a function of one unit may be implemented by a plurality of units, or functions of a plurality of units are implemented by one unit. In another embodiment of this application, the coding apparatus may further include another unit. In actual application, these functions may alternatively be cooperatively implemented by another unit and may be cooperatively implemented by a plurality of units. According to another embodiment of this application, a computer program (including program code) that can perform the operations related to the corresponding method shown in FIG. 12 may run on a general computing device such as a computer including processing elements and memory elements such as a central processing unit (CPU), a random access memory (RAM), and a read-only memory (ROM), to construct the coding apparatus shown in FIG. 15 and implement the image processing method in the embodiments of this application. The computer program may be recorded in, for example, a computer-readable recording medium, and may be loaded into the computing device by using the computer-readable recording medium, and run in the computing device.

In this embodiment of this application, in the process of coding the image by the coding end, the predicted value of the second component of the current coding block can be predicted based on the first component of reconstructed pixels, thereby implementing cross-component prediction and improving prediction efficiency. In addition, cross-component prediction is specifically implemented by using the relatively refined cross-component prediction model, and the cross-component prediction model is constructed based on similarity between mapping relationships between different components of reconstructed pixels. Therefore, higher-quality predicted pixels of the current coding block can be generated based on the refined cross-component prediction model, thereby significantly improving prediction quality and coding efficiency.

FIG. 16 is a schematic structural diagram of a computer device according to an exemplary embodiment of this application. With reference to FIG. 16, the computer device includes a processor 1601, a communication interface 1602, and a computer-readable storage medium 1603. The processor 1601, the communication interface 1602, and the computer-readable storage medium 1603 may be connected by using a bus or in other manners. The communication interface 1602 is configured to receive and send data. The computer-readable storage medium 1603 may be stored in a memory in a computer device. The computer-readable storage medium 1603 is configured to store a computer program, where the computer program includes program instructions. The processor 1601 is configured to execute the program instructions stored in the computer-readable storage medium 1603. The processor 1601 (or referred to as a central processing unit (CPU)) is a computing core and a control core of the computer device, is configured to implement one or more instructions, and is specifically configured to load and execute the one or more instructions to implement a corresponding method flow or a corresponding function.

An embodiment of this application further provides a computer-readable storage medium (memory). The computer-readable storage medium is a memory device in a computer device, and is configured to store a program and data. The computer-readable storage medium herein may include both a storage medium constructed in the computer device and certainly an extended storage medium supported by the computer device. The computer-readable storage medium provides a storage space that stores an operating system of the computer device. In addition, one or more instructions that are loaded and executed by the processor 1601 are further stored in the storage space. The instructions may be one or more computer programs (including program code). The computer-readable storage medium herein may be a high-speed RAM memory, or a non-volatile memory, for example, at least one magnetic disk storage. In some embodiments, the computer-readable storage medium herein may alternatively be at least one computer-readable storage medium located away from the processor.

In an embodiment, the computer-readable storage medium stores one or more instructions. The processor 1601 loads and executes the one or more instructions stored in the computer-readable storage medium, to implement corresponding operations in the embodiments of the foregoing image processing method. In a specific implementation, the one or more instructions in the computer-readable storage medium may be loaded by the processor 1601 to perform the foregoing image processing method.

Based on the same inventive concept, the problem-solving principle and beneficial effects of the computer device provided in this embodiment of this application are similar to those of the image processing method in the method embodiments of this application. Refer to the principle and beneficial effects of the implementation of the method. For brevity, details are not described herein again.

An embodiment of this application further provides a computer program product or a computer program, where the computer program product or the computer program includes computer instructions stored in a computer-readable storage medium. A processor of a computer device reads the computer instructions from the computer-readable storage medium, and the processor executes the computer instructions, so that the computer device performs the image processing method.

A person of ordinary skill in the art may be aware that, in combination with the examples described in embodiments disclosed in this application, units and algorithm operations may be implemented by electronic hardware or a combination of computer software and electronic hardware. Whether the functions are executed in a mode of hardware or software depends on particular applications and design constraint conditions of the technical solutions. A person skilled in the art may use different methods to implement the described functions for each particular application, but it is not considered that the implementation goes beyond the scope of this application.

All or some of the above embodiments may be implemented by means of software, hardware, firmware or their combinations. When the software is configured for implementation, all or some of the embodiments may be implemented in a form of a computer program product. The computer program product includes one or more computer instructions. When the computer program instructions are loaded and executed on a computer, all or some of the processes or functions according to the embodiments of the present disclosure are produced. The computer may be a general-purpose computer, a dedicated computer, a computer network, or other programmable devices. The computer instruction may be stored in the computer-readable storage medium or transmitted through the computer-readable storage medium. The computer instructions may be transmitted from a website, computer, server, or data center to another website, computer, server, or data center in a wired (for example, a coaxial cable, an optical fiber, or a digital subscriber line (DSL)) or wireless (for example, infrared, radio, or microwave) manner. The computer-readable storage medium may be any usable medium capable of being accessed by a computer or include one or more data processing devices such as a server and a data center integrated with a usable medium. The usable medium may be a magnetic medium (for example, a soft disk, a hard disk, or a magnetic tape), an optical medium (for example, a DVD), a semiconductor medium (for example, a solid-state disk (SSD)), or the like.

The foregoing descriptions are merely specific implementations of this application, but are not intended to limit the protection scope of this application. Any variation or replacement readily figured out by any person skilled in the art within the technical scope disclosed in the present disclosure shall fall within the protection scope of this application. Therefore, the protection scope of this application is subject to the protection scope of the claims.

What is claimed is:

1. An image processing method performed by a computer device, the method comprising:
determining a current coding block in an image bitstream, the current coding block comprising a first component and a second component;
obtaining a cross-component prediction model, the cross-component prediction model indicating a mapping relationship between the first component of the current coding block and the second component of the current coding block;
performing cross-component prediction on the current coding block based on the mapping relationship by inputting a reconstructed value of the first component of the current coding block to the cross-component prediction model to obtain a predicted value of the second component of the current coding block; and
reconstructing the current coding block using the reconstructed value of the first component and the predicted value of the second component of the current coding block.

2. The method according to claim 1, wherein the first component and the second component comprise any one of the following:
the first component is a luminance component Y, and the second component is a first chrominance component U; or
the first component is a luminance component Y, and the second component is a second chrominance component V; or
the first component is a first chrominance component U, and the second component is a second chrominance component V; or
the first component is a luminance component and a first chrominance component YU, and the second component is a second chrominance component V; or
the first component is a luminance component and a second chrominance component YV, and the second component is a first chrominance component U.

3. The method according to claim 1, wherein the obtaining the cross-component prediction model comprises:
constructing an expression of the cross-component prediction model of the current coding block based on sampling points of reconstructed pixels in the image bitstream in a first component dimension and sampling points of the reconstructed pixels in a second component dimension;
determining a template region in the second component dimension for the current coding block;
selecting target sampling points for model calculation from the template region; and
calculating a model parameter in the expression of the cross-component prediction model based on the target sampling points in a calculation manner of solving a linear equation, to obtain the cross-component prediction model.

4. The method according to claim 3, wherein the expression of the cross-component prediction model comprises a plurality of prediction sub-equations; and the constructing an expression of the cross-component prediction model of the current coding block based on sampling points of reconstructed pixels in the image bitstream in a first component dimension and sampling points of the reconstructed pixels in a second component dimension comprises:
constructing a plurality of cross-component matching pairs of the reconstructed pixels in the image bitstream; wherein one cross-component matching pair comprises one first component and one second component, the first component comprises one or more sampling points, the second component comprises one sampling point, and a position of a sampling point of the one or more sampling points comprised in the first component and a position of the sampling point comprised in the second component are associated positions or the same position;
determining a target prediction manner, and generating a target prediction mode according to the target prediction manner, wherein the target prediction manner is used to indicate: selecting one prediction mode from Q prediction modes as the target prediction mode, or selecting at least two prediction modes from the Q prediction modes for weighting processing to obtain the target prediction mode, Q is an integer greater than or equal to 1, and the target prediction mode is used to represent prediction logic for predicting the second component based on the first component; and
generating a prediction sub-equation for each cross-component matching pair of the plurality of cross-component matching pairs according to the target prediction mode.

5. The method according to claim 4, before the constructing a plurality of cross-component matching pairs of the reconstructed pixels in the image bitstream, further comprising:
obtaining reconstructed pixels of the first component, and preprocessing the reconstructed pixels of the first component, to obtain sampling points of the reconstructed pixels of the first component in the first component dimension; and/or
obtaining reconstructed pixels of the second component, and preprocessing the reconstructed pixels of the second component, to obtain sampling points of the reconstructed pixels of the second component in the second component dimension; wherein
a preprocessing manner of the preprocessing comprises at least one of the following:
resampling the first component when resolutions of the first component and the second component are different;
triggering to perform the operation of constructing a plurality of cross-component matching pairs of reconstructed pixels in the image bitstream when the resolutions of the first component and the second component are different; and
filtering the first component by using one or more filters.

6. The method according to claim 5, wherein the cross-component prediction model is constructed based on the target prediction mode, the target prediction mode is one of Q prediction modes, or the target prediction mode is obtained through weighting processing of at least two of the Q prediction models, Q is an integer greater than or equal to 1, and a manner of constructing the prediction mode comprises:
constructing the prediction mode based on the mapping relationship between the first component and the second component, the sampling points of the reconstructed pixels in the image bitstream in the first component dimension, and the sampling points of the reconstructed pixels in the image bitstream in the second component dimension; wherein
the prediction mode comprises at least one monomial and a model parameter of each of the at least one monomial, the monomial comprises at least one of the following: a constant term and a sampling point term that is constructed by at least one sampling point in the first component, a manner of constructing the sampling point term comprises one or more of the following: a single sampling point, an m1^{th}-order of a single sampling point, a multiple of a single sampling point, an operation formula formed by at least two sampling points, an m1^{th}-order of an operation formula formed by at least two sampling points, and an operation formula formed by an m3^{th}-order of some sampling points of at least two sampling points and a remaining sampling point of the at least two sampling points, m1, m2, and m3 are the same or different and m1, m2, and m3 are non-zero real numbers, and the model parameter of each of the at least one monomial is obtained by parsing the image bitstream or calculated based on the model.

7. The method according to claim 3, wherein the determining the template region in the second component dimension for the current coding block comprises:
determining a plurality of neighboring regions of the current coding block in the second component dimension; and
selecting the template region from the plurality of neighboring regions for the current coding block.

8. The method according to claim 7, wherein the plurality of neighboring regions comprise at least one of the following: a region A located on the upper left of the current coding block, a region B located right above the current coding block, a region C located on the upper right of the current coding block, a region D located on the left of the current coding block, and a region E located on the lower left of the current coding block.

9. The method according to claim 1, before the obtaining the cross-component prediction model, further comprising:
determining whether cross-component prediction needs to be performed on the current coding block by using the cross-component prediction model; wherein
a condition for determining whether cross-component prediction needs to be performed on the current coding block comprises one or more of the following:
determining, according to a prediction index obtained by parsing the image bitstream, whether cross-component prediction needs to be performed on the current coding block; wherein the prediction index is located in one or more of a sequence header, an image header, a slice header, and a largest coding block in the image bitstream;
determining, according to a block characteristic of the current coding block, whether cross-component prediction needs to be performed on the current coding block; wherein the block characteristic of the current coding block comprises: a size of the current coding block and a position of the current coding block in the image; and
determining, according to a template characteristic of the template region corresponding to the current coding block, whether cross-component prediction needs to be performed on the current coding block; wherein the template characteristic of the template region comprises: a template area of the template region and/or a quantity of usable sampling points comprised in the template region, cross-component prediction is performed on the current coding block when the template area is greater than an area threshold; and cross-component prediction is performed on the current coding block when the quantity of usable sampling points in the template region is greater than a quantity of model parameters comprised in the expression of the cross-component prediction model of the current coding block.

10. The method according to claim 1, wherein the obtaining the cross-component prediction model comprises:
determining a model parameter for calculating the cross-component prediction model; wherein the model parameter is preset or obtained by parsing the image bitstream; and
obtaining a calculated cross-component prediction model based on the model parameter.

11. A computer device,
a processor, configured to execute a computer program; and
a computer-readable storage medium, having a computer program stored therein, the computer program, when executed by the processor, causing the computer device to implement an image processing method including:
determining a current coding block in an image bitstream, the current coding block comprising a first component and a second component;
obtaining a cross-component prediction model, the cross-component prediction model indicating a mapping relationship between the first component of the current coding block and the second component of the current coding block;
performing cross-component prediction on the current coding block based on the mapping relationship by inputting a reconstructed value of the first component of the current coding block to the cross-component prediction model to obtain a predicted value of the second component of the current coding block; and
reconstructing the current coding block using the reconstructed value of the first component and the predicted value of the second component of the current coding block.

12. The computer device according to claim 11, wherein the first component and the second component comprise any one of the following:
the first component is a luminance component Y, and the second component is a first chrominance component U; or
the first component is a luminance component Y, and the second component is a second chrominance component V; or
the first component is a first chrominance component U, and the second component is a second chrominance component V; or
the first component is a luminance component and a first chrominance component YU, and the second component is a second chrominance component V; or
the first component is a luminance component and a second chrominance component YV, and the second component is a first chrominance component U.

13. The computer device according to claim 11, wherein the obtaining the cross-component prediction model comprises:
constructing an expression of the cross-component prediction model of the current coding block based on sampling points of reconstructed pixels in the image bitstream in a first component dimension and sampling points of the reconstructed pixels in a second component dimension;
determining a template region in the second component dimension for the current coding block;
selecting target sampling points for model calculation from the template region; and
calculating a model parameter in the expression of the cross-component prediction model based on the target sampling points in a calculation manner of solving a linear equation, to obtain the cross-component prediction model.

14. The computer device according to claim 13, wherein the expression of the cross-component prediction model comprises a plurality of prediction sub-equations; and the constructing an expression of the cross-component prediction model of the current coding block based on sampling points of reconstructed pixels in the image bitstream in a first component dimension and sampling points of the reconstructed pixels in a second component dimension comprises:
constructing a plurality of cross-component matching pairs of the reconstructed pixels in the image bitstream; wherein one cross-component matching pair comprises one first component and one second component, the first component comprises one or more sampling points, the second component comprises one sampling point, and a position of a sampling point of the one or more sampling points comprised in the first component and a position of the sampling point comprised in the second component are associated positions or the same position;
determining a target prediction manner, and generating a target prediction mode according to the target prediction manner, wherein the target prediction manner is used to indicate: selecting one prediction mode from Q prediction modes as the target prediction mode, or selecting at least two prediction modes from the Q prediction modes for weighting processing to obtain the target prediction mode, Q is an integer greater than or equal to 1, and the target prediction mode is used to represent prediction logic for predicting the second component based on the first component; and
generating a prediction sub-equation for each cross-component matching pair of the plurality of cross-component matching pairs according to the target prediction mode.

15. The computer device according to claim 14, before the constructing a plurality of cross-component matching pairs of the reconstructed pixels in the image bitstream, wherein the method further comprises:
obtaining reconstructed pixels of the first component, and preprocessing the reconstructed pixels of the first component, to obtain sampling points of the reconstructed pixels of the first component in the first component dimension; and/or
obtaining reconstructed pixels of the second component, and preprocessing the reconstructed pixels of the second component, to obtain sampling points of the reconstructed pixels of the second component in the second component dimension; wherein
a preprocessing manner of the preprocessing comprises at least one of the following:
resampling the first component when resolutions of the first component and the second component are different;
triggering to perform the operation of constructing a plurality of cross-component matching pairs of reconstructed pixels in the image bitstream when the resolutions of the first component and the second component are different; and
filtering the first component by using one or more filters.

16. The computer device according to claim 15, wherein the cross-component prediction model is constructed based on the target prediction mode, the target prediction mode is one of Q prediction modes, or the target prediction mode is obtained through weighting processing of at least two of the Q prediction models, Q is an integer greater than or equal to 1, and a manner of constructing the prediction mode comprises:
constructing the prediction mode based on the mapping relationship between the first component and the second component, the sampling points of the reconstructed pixels in the image bitstream in the first component dimension, and the sampling points of the reconstructed pixels in the image bitstream in the second component dimension; wherein
the prediction mode comprises at least one monomial and a model parameter of each of the at least one monomial, the monomial comprises at least one of the following: a constant term and a sampling point term that is constructed by at least one sampling point in the first component, a manner of constructing the sampling point term comprises one or more of the following: a single sampling point, an m1^{th}-order of a single sampling point, a multiple of a single sampling point, an operation formula formed by at least two sampling points, an m1^{th}-order of an operation formula formed by at least two sampling points, and an operation formula formed by an m3^{th}-order of some sampling points of at least two sampling points and a remaining sampling point of the at least two sampling points, m1, m2, and m3 are the same or different and m1, m2, and m3 are non-zero real numbers, and the model parameter of each of the at least one monomial is obtained by parsing the image bitstream or calculated based on the model.

17. The computer device according to claim 13, wherein the determining the template region in the second component dimension for the current coding block comprises:
determining a plurality of neighboring regions of the current coding block in the second component dimension; and
selecting the template region from the plurality of neighboring regions for the current coding block.

18. The computer device according to claim 17, wherein the plurality of neighboring regions comprise at least one of the following: a region A located on the upper left of the current coding block, a region B located right above the current coding block, a region C located on the upper right of the current coding block, a region D located on the left of the current coding block, and a region E located on the lower left of the current coding block.

19. The computer device according to claim 11, wherein the obtaining the cross-component prediction model comprises:
determining a model parameter for calculating the cross-component prediction model; wherein the model parameter is preset or obtained by parsing the image bitstream; and
obtaining a calculated cross-component prediction model based on the model parameter.

20. A non-transitory computer-readable storage medium having a computer program stored therein, the computer program, when loaded and executed by a processor of a computer device, causing the computer device to perform an image processing method including:
determining a current coding block in an image bitstream, the current coding block comprising a first component and a second component;
obtaining a cross-component prediction model, the cross-component prediction model indicating a mapping relationship between the first component of the current coding block and the second component of the current coding block;
performing cross-component prediction on the current coding block based on the mapping relationship by inputting a reconstructed value of the first component of the current coding block to the cross-component prediction model to obtain a predicted value of the second component of the current coding block; and
reconstructing the current coding block using the reconstructed value of the first component and the predicted value of the second component of the current coding block.
